(19) United States
(12) Patent Application Publication
(10) Pub. No.: US 2020/0189482 A1
(43) Pub. Date: Jun. 18, 2020

(54) MODULAR MOTOR VEHICLE INTEGRATED CARRIER RACK AND STORAGE SYSTEM WITH UNIVERSAL CONNECTIONS

(71) Applicant: Mark A. Anton, Newport Beach, CA (US)

(72) Inventor: Mark A. Anton, Newport Beach, CA (US)

(21) Appl. No.: 16/676,362

(22) Filed: Nov. 6, 2019

Related U.S. Application Data
(63) Continuation of application No. 15/711,720, filed on Sep. 21, 2017, now abandoned.
(60) Provisional application No. 62/554,767, filed on Sep. 6, 2017.
(60) Provisional application No. 62/545,409, filed on Aug. 14, 2017.
(60) Provisional application No. 62/462,285, filed on Feb. 22, 2017.
(60) Provisional application No. 62/431,792, filed on Dec. 8, 2016.
(60) Provisional application No. 62/397,896, filed on Sep. 21, 2016.

(51) Int. Cl. B60R 9/10; B60R 9/00; B60R 9/06

(52) U.S. Cl. CPC B60R 9/10; B60R 9/06; B60R 9/00

(57) ABSTRACT

Systems, devices, and methods, of securing and transporting cargo and items using a vehicle including modular carrier racks and various engagement components and features.

### CROSS REFERENCE TO RELATED APPLICATIONS

The present application is a continuation of U.S. patent application Ser. No. 15/711,720, filed Sep. 21, 2017, and claims priority pursuant to 35 U.S.C. § 119(e) to U.S. Provisional Patent Application No. 62/554,767 filed Sep. 6, 2017; U.S. Provisional Patent Application No. 62/545,409 filed Aug. 14, 2017; U.S. Provisional Patent Application No. 62/462,285 filed Feb. 22, 2017; U.S. Provisional Patent Application No. 62/431,792 filed Dec. 8, 2016; U.S. Provisional Patent Application No. 62/397,896 filed Sep. 21, 2016; the disclosures of each of which are hereby incorporated by reference in their entireties.

The present application is related to U.S. patent application Ser. No. 15/054,001 filed Feb. 25, 2016; U.S. Provisional Patent Application No. 62/276,144 filed Jan. 7, 2016; U.S. Provisional Patent Application No. 62/163,638 filed May 19, 2015; U.S. Provisional Patent Application No. 62/120,825 filed Feb. 25, 2015, the disclosures of all of which are hereby incorporated by reference in their entireties. This application is also related to U.S. patent application Ser. No. 14/214,407 filed Mar. 14, 2014; U.S. Provisional Patent Application No. 61/803,101 filed Mar. 18, 2013; and U.S. Provisional Patent Application No. 61/801,951 filed Mar. 15, 2013, the disclosures of all of which are hereby incorporated by reference in their entireties. Further, this application is also related to U.S. Pat. No. 6,752,302 by Anton, patented Jun. 22, 2004, which is hereby incorporated by reference in its entirety.

### FIELD OF THE INVENTION

The subject matter described herein relates generally to lightweight, modular carrier rack and storage systems for motor vehicles, and more particularly to carrier rack systems that are integrated into a motor vehicle or can be attached to a tow hitch—carrier rack and storage systems that are designed through unique, universal connections to carry and store items such as bicycles, skis, snowboards, surfboards, wave boards, wheelchairs, scooters, luggage, fishing gear, accessories, and others.

### BACKGROUND OF THE INVENTION

Present carrier rack systems for motor vehicles, such as cars, trucks, vans, minivans, sports utility vehicles (SUV's), and motor homes, generally involve a system of multiple straps attached onto the vehicle, a system attached to a universal tow hitch, a system attached to a roof, or a system attached to a bumper. These systems are cumbersome, heavy, and difficult to store at home or in the vehicle when the systems are not in use. Additionally, these systems may not be adaptable to all types of vehicles, and when some of these systems are attached, they often make it difficult to access the trunk or doors. These systems are susceptible to theft and may scratch and damage the vehicle when attached and used.

In the case of systems involving multiple straps, these systems are complicated to attach onto the vehicle and may loosen with use over time. In the case of systems attached to the roof, these systems create wind resistance when the car is moving and are difficult to access. For carrier systems that are attached to bumpers, these systems damage the sensitive bumper mechanism and have limited supportability. For trailer hitch systems, the systems are heavy and difficult to attach, detach, and store.

Additionally, organization and storage space are important for people from all walks of life. Improved organization and storage save time when preparing for activities. It saves space in a home garage, basement, storage garage or shed, closet, office, home, room or any other place things are stored. It may also help prevent injuries that can occur from tripping, falling, dropping, knocking over unstable items, or other accidental or unintentional actions. Likewise, it may save money because when items fall, they may be individually harmed in the form of dents, breaks, chips or other damage or may dent, break, chip, or damage items which they collide with such as motor vehicles.

Accordingly, this invention creates an interface between machine and cargo. It is a modular platform whose universal designs and connections allow simple and easy vehicular transport and storage of multiple types of recreational equipment and activity pods.

### SUMMARY

The present invention is directed to carrier rack and storage systems for motor vehicles, and more particularly to carrier rack and storage systems that are integrated into motor vehicles at the time of vehicle manufacture or after production (retrofitting) and it can also attach to current tow hitches in some embodiments.

In accordance with one aspect of the present invention, a receiver of a carrier rack system is integrated into a portion of a motor vehicle with a rear wall, such as a tailgate of a pickup truck, a trunk lid of a car, a rear license plate wall, or a rear door of a minivan or sports utility vehicle, having an inside and outside. The system generally includes a receiving unit, having rear and forward ends, integrated into the rear wall, an immobilizing system attached to the receiving unit, and/or a carrier bar attached to the receiving unit. The receiving unit may be positioned such that the rear end is directed toward the back of the vehicle and forms an engaging structure in the rear wall that can be aesthetically hidden from view with a cover or cap.

The carrier bar can generally be universal, meaning it can be attached to any vehicle with a receiving unit and can have any attachments placed on the carrier bar to carry a variety of items. The carrier bar is generally lightweight, easily stored in the vehicle when not in use, and easily attachable to the receiving unit when use is desired. When in use, the carrier bar will not damage the paint on the vehicle. Also, supportability is improved with the carrier because it can be positioned at an optimum level on the vehicle, providing ample distance from the ground when an item or storage pod is attached to the carrier bar and providing less stress to a person's back when the person is loading the item or storage pod onto the carrier bar. The invention is advantageous in that it provides a lightweight and easy to use carrier rack and storage system that can be integrated into motor or other vehicles. The invention is further advantageous in that it will not damage or scratch the vehicle. The invention is yet further advantageous in that it provides a simplistic storage system using universal carrier connections to easily attach and detach cargo for transport in which all items for a particular activity are kept together and may be easily taken along when going to an activity and stored when returning from the activity.

In accordance with another aspect of the invention, the receiving unit described above is integrated into a portion of a vehicle having a side wall, such as a side of a truck bed, a side door, a side of a trunk lid, or other side panel of a vehicle. Interior walls are also contemplated.

In accordance with another aspect of the invention, the receiving unit described above is integrated into a portion of a motor vehicle having a front end, such as a front end of a bus, motor home, van, truck, SUV, or minivan.

In accordance with another aspect of the invention a storage system is provided which allows a user to easily transport and store items associated with a particular activity in a convenient compartment or compartmentalized pod. This provides simplicity in storing commonly used items for one activity, ease of transport, and ease of storage in any location necessary including in the home, office, garage, basement, closet, on a wall, or in or on virtually any other location desired.

Other systems, devices, methods, features and advantages of the subject matter described herein will be or will become apparent to one with skill in the art upon examination of the following figures and detailed description. It is intended that all such additional systems, devices, methods, features and advantages be included within this description, be within the scope of the subject matter described herein and be protected by the accompanying claims. In no way should the features of the example embodiments be construed as limiting the appended claims, absent express recitation of those features in the claims.

### BRIEF DESCRIPTION OF THE DRAWING(S)

The details of the subject matter set forth herein, both as to its structure and operation, may be apparent by study of the accompanying figures, in which like reference numerals refer to like parts. The components in the figures are not necessarily to scale, emphasis instead being placed upon illustrating the principles of the subject matter. Moreover, all illustrations are intended to convey concepts, where relative sizes, shapes and other detailed attributes may be illustrated schematically rather than literally or precisely.

FIGS. 1A-1I show an example embodiment of a cargo carrier and adapter bar device and coupling mechanisms for connection with a sport vehicle from various angled views.

FIG. 2 shows an example embodiment of an adapter bar device with receivers.

FIG. 3 shows an example embodiment of a view of the rear end of a sport vehicle.

FIG. 4 shows an example embodiment of a view of a spare tire of a sport vehicle.

FIG. 5 shows an example embodiment of an interior of a spare tire of a sport vehicle.

FIG. 6 shows an example embodiment of a golf bag attachment mechanism for use with a cargo carrier and storage adapter bar.

FIG. 7 shows an example embodiment of a golf bag with a coupled attachment mechanism.

FIG. 8 shows an example embodiment of a close perspective view of a golf bag with a coupled attachment mechanism.

FIG. 9 shows an example embodiment of a close straight view of a golf bag with a coupled attachment mechanism.

FIG. 10 shows an example embodiment of a golf bag with a coupled attachment mechanism attached to a cargo carrier and adapter bar device.

FIG. 11 shows an example embodiment of an electromechanical human chair device coupled with a cargo carrier and adapter bar device

FIG. 12 shows an example embodiment of an electromechanical human chair device for coupling with a cargo carrier and adapter bar device.

FIG. 13 shows an example embodiments of an electromechanical human chair device for coupling with a cargo carrier and adapter bar device from various perspective views.

FIG. 14 shows an example embodiment of an electromechanical human chair device for coupling with a cargo carrier and adapter bar device.

FIG. 15 shows an example embodiment of an electromechanical human standing transportation device for coupling with a cargo carrier and adapter bar device.

FIG. 16 shows an example embodiment of a bottle carrier device with attached cargo carrying attachment.

FIG. 17 shows an example embodiment of a bottle with attached cargo carrying attachment.

FIG. 18 shows an example embodiment of a wall mounting for a cargo carrying and storage device.

FIG. 19 shows an example embodiment of a cargo carrier device with hinged wings.

FIGS. 20-23 show example embodiments of an adaptor bar for use on a bicycle that can be removable, adjustable horizontal support adaptor bars.

FIGS. 24A-24C show example embodiments of bicycle carrying apparatuses.

FIGS. 25A-25F show example embodiments of a lockable clamp for use with a bike seat post.

FIGS. 26A-26H show example embodiments of adaptor bars with removable clamps.

FIGS. 27A and 27B show example embodiments of a carrier bar and support system including components for coupling with the rear of a vehicle.

FIGS. 28A and 28B show a variety of embodiments for electrical, magnetic, and electro-magnetic systems or sub-systems can be coupled or integrated with carrier or storage bars.

FIG. 29A shows an example embodiment of a trapezoidal mount that is not yet mechanically coupled to an item or carrier bar.

FIG. 29B shows an example embodiment of a trapezoidal mount that is not yet mechanically coupled to an item or carrier bar.

FIG. 29C shows an example embodiment of a trapezoidal mount that is not yet mechanically coupled to an item or carrier bar.

FIG. 30A shows an example embodiment of a top view of a female receiver.

FIG. 30B shows an example embodiment of a cross sectional view of a female receiver.

FIG. 31A shows an example embodiment of a female receiver clip view from above the receiver area and a side view of a male linking unit mounted on a bar.

FIG. 31B shows an example embodiment of a female receiver clip view from above the receiver area and a side view of a male linking unit mounted on a bar.

FIG. 32 shows an example embodiment of a carrier bar and various mounting locations for viewing cameras.

FIG. 33 shows a variety of example embodiments of exterior view camera's that can be coupled or integrated with carrier bars and other carrying devices and apparatuses.

FIGS. 34A-34D show example embodiments images of safety straps coupled with cargo carrier bars.

### DETAILED DESCRIPTION

Before the present subject matter is described in detail, it is to be understood that this disclosure is not limited to the particular embodiments described, as such may, of course, vary. It is also to be understood that the terminology used herein is for the purpose of describing particular embodiments only, and is not intended to be limiting, since the scope of the present disclosure will be limited only by the appended claims.

In various embodiments described herein, male coupling mechanisms can be attached, coupled, or otherwise bonded to currently existing or later developed standard manufacturer or aftermarket crossbars that are located on the roofs of different types of vehicles. In other embodiments, female coupling mechanisms can be attached, coupled, or otherwise bonded to currently existing or later developed standard manufacturer or aftermarket crossbars on the roofs of different types of vehicles. In some embodiments, combinations of both can be attached or bonded to crossbars. Further, the embodiments herein are not limited to the roofs, but could also be located on the sides, rear, hood, grill, pickup truck bed, or other locations on vehicles. In some embodiments, these male and female coupling mechanisms can have a trapezoidal shaped cross-section. In use, various types of cargo, containers, bags, and other items with one or more male, female or both types of coupling mechanisms can be coupled with complementary shaped coupling mechanisms that are mounted on a vehicle, in order to safely and securely transport the items. As an example, a surfboard with a coupling mechanism, also referred to herein as adaptor, can be attached by clipping, coupling, joining, or otherwise connecting with its complementary shaped mechanism.

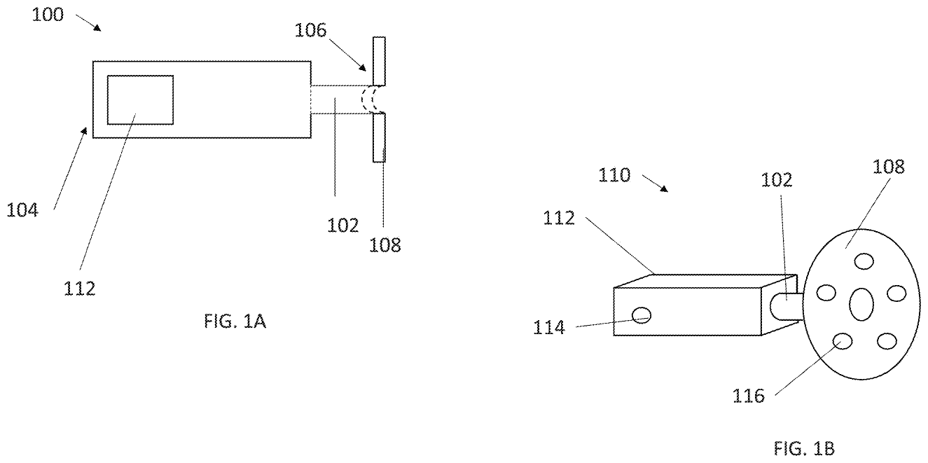

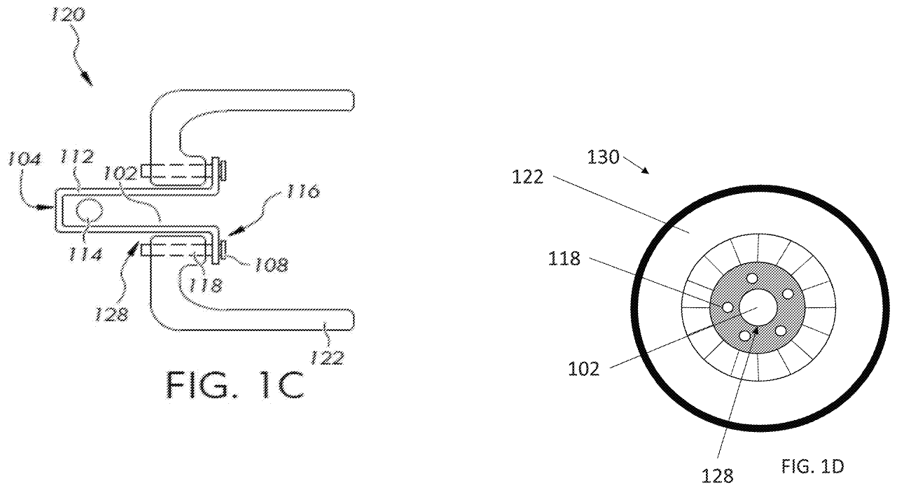

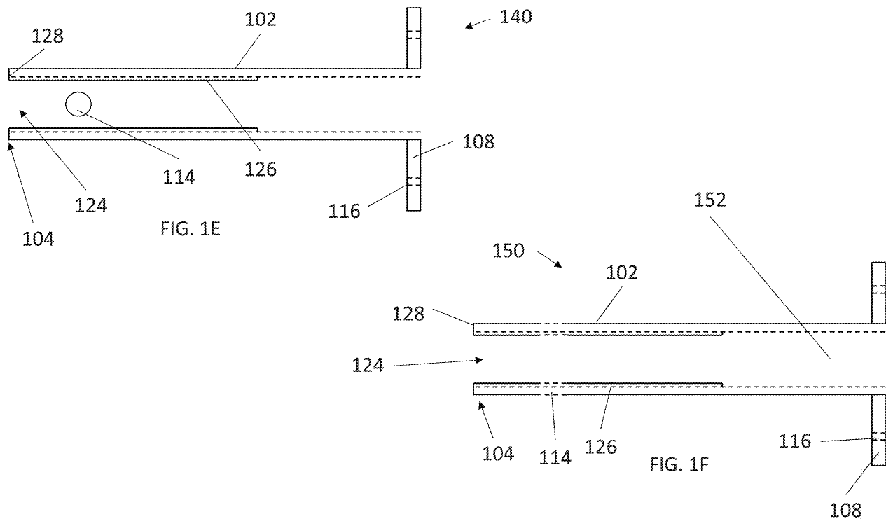

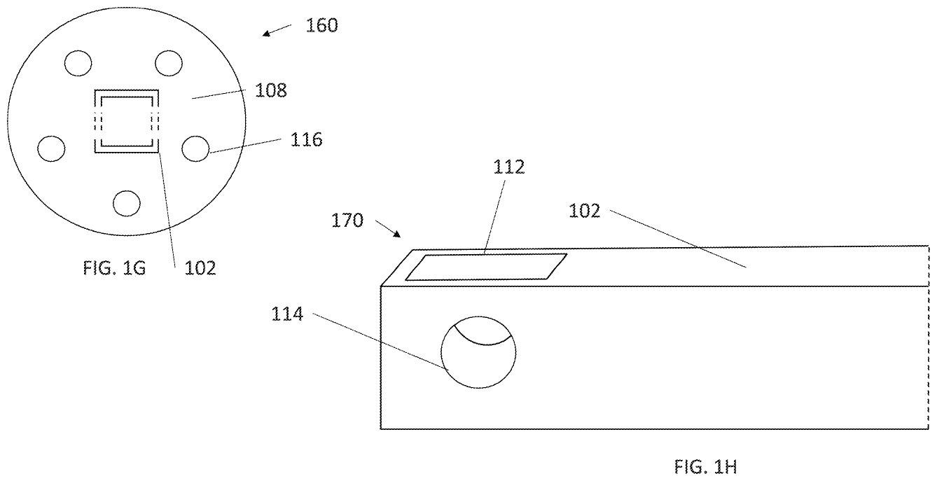

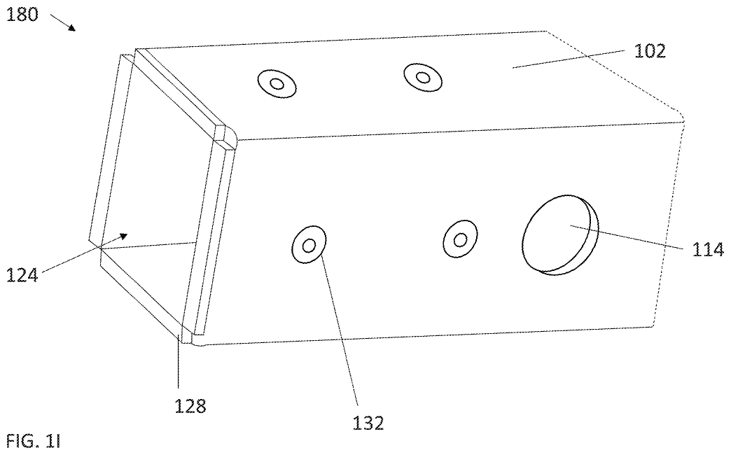

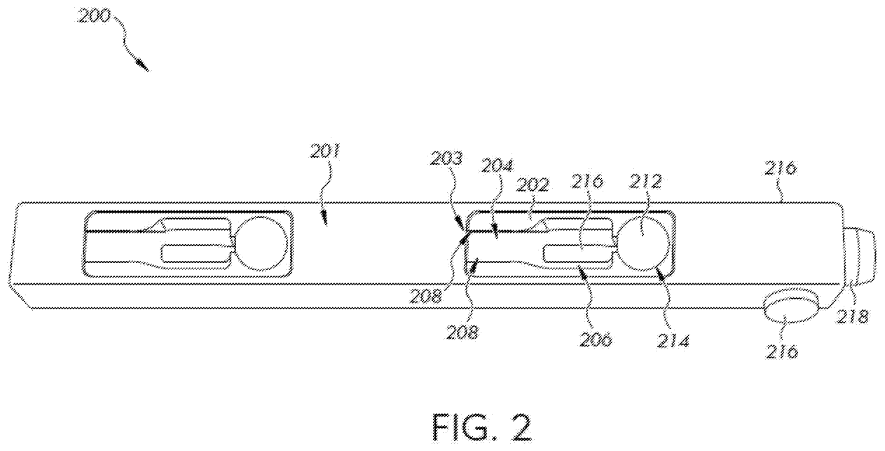

In general, FIGS. 1A-1I depict a “Spare Wheel (SW) SportHitch” that allows for modification of sport utility vehicle spare tire area as seen in FIGS. 3-5 for receiving a cargo carrying bar as seen in FIG. 2 that can be used to transport cargo. In the example embodiments, a SW SportHitch receiver unit can be a single unit and can be coupled or positioned within a central location of a spare tire (e.g. see FIGS. 3-5), as is commonly seen on the rear of Jeeps and other sport utility vehicles and vans (e.g. see FIG. 3), which are typically located a sufficient distance above a ground surface. As such, in some embodiments (e.g. FIGS. 1E-1G, 1I) that a cargo carrier bar (e.g. see FIG. 2) may not require additional vertical extension bars in order to support cargo so that it will not impact a ground surface during transportation. Therefore, a single cargo carrier bar may be inserted horizontally or at an upward or downward angle into a receiver located in or on a trunk lid, spare wheel, backdoor, back hatch, or other location of a vehicle. In other words, no stair-stepped cargo carrier bars with vertical sections are required for such SportHitch receiver unit embodiments. However, in some embodiments (e.g. see FIGS. 1A-1C, 1H), orifices can be provided to allow for vertically oriented carrier bars to be received as well. Some embodiments may provide both vertical and horizontal receiving orientations.

As shown in FIGS. 1A-1I, a SportHitch spare wheel adaptor bar can have a body 102 that allows users to attach cargo supporting transportation and storage bars to traditionally mounted spare wheels, such as those frequently seen on the rear exterior surface of sport utility vehicles and other types of vehicles. One example is the Jeep brand of vehicle, with the spare tire mounted on the rear exterior surface of its rear-facing wall or door (e.g. see FIGS. 2A-2C). These adaptors can be positioned between a spare tire and a mount on the exterior rear wall or surface of the vehicle. As such, the spare tire can be removed from vehicle when not in use to provide a cargo transportation supporting surface.

FIG. 1A shows an example embodiment diagram 100 of a spare wheel adaptor bar for securing and transporting cargo from a top-down view. As shown, body 102 of adaptor bar can have a distal end 104 that extends in a distal direction and can be coupled at a proximal end 106 with a circular or other shaped plate 108, that is mounted to a rear surface of a vehicle. A hole or other orifice 110 through an upper surface of body 102 can extend partially or fully into a hollow central cavity of body 102 or, if body 102 is solid, into part of or fully through body 102.

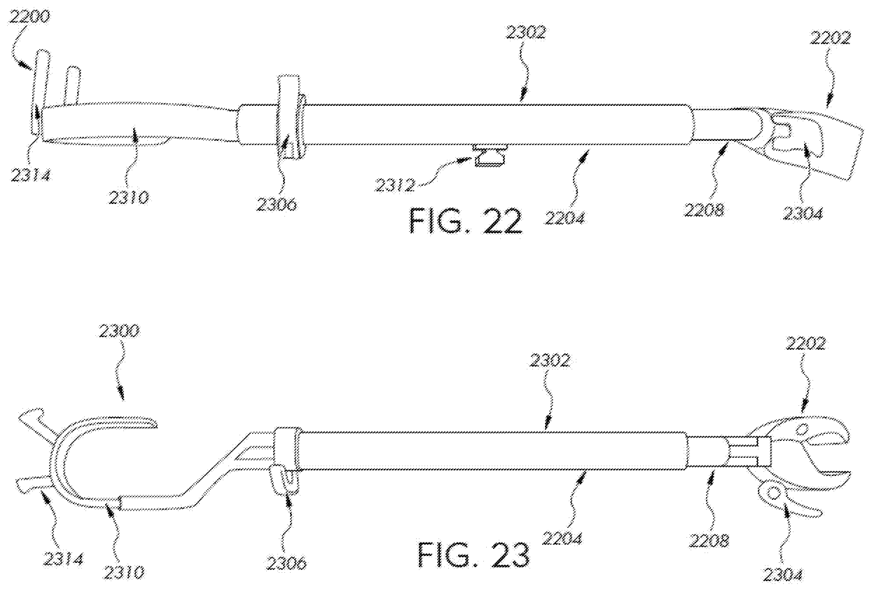

FIG. 1B shows an example embodiment diagram 110 of a spare wheel adaptor bar for securing and transporting cargo from an oblique side view. As shown in an example embodiment, body 102 can have one or more round or other shaped holes or orifices 114 in its sides that can receive a complementary shaped pin or button (e.g. see 216 of FIG. 2) that is connected to, part of, or otherwise coupled with a cargo carrying bar (e.g. see 201 of FIG. 22). As such, when the cargo carrying bar is inserted into orifice 112, the button(s) can extend partially or fully through orifice(s) 114 to lock and secure the cargo carrying bar in place.

Also shown in FIG. 1B is circular plate 108. In use, mounting plate 108 can be located inside a central hole of a spare tire, such that a cylindrical or other shaped body 102 of an adaptor bar can be coupled with it. Here, mounting plate 108 has one or more mounting holes 116 (five holes are shown) that extend through it. These can receive pins, screws, nails, bolts, or other securing components that can be locked into place with respect to the rear, exterior surface of the vehicle. In some embodiments, mounting plate can be mounted directly to a wall of the vehicle, while in others it can be mounted to a supporting structure.

In various embodiments, a proximal end of body 102 can have ridges, grooves, or both, such that it can be screwed or otherwise coupled with complementary structures of an accompanying mounting plate 108. As shown, this can be a central location on plate 108, although in some embodiments it can have different locations. A pin (not shown) on plate 108 can be slid or otherwise positioned inside or through the cylindrical section so that the cylindrical part is prevented from unscrewing with respect to its location. This can be through a side wall of body 102 or in a central location of cylindrical body 102. Thereafter, the spare tire can be bolted onto the normal spare tire mount.

A distal, posterior, or rear end 104 can include a section of the adaptor bar body 102 that has a square or other cross-sectional shaped tube, which may or may not be differently shaped from the front portion of body 102. As shown, square cross-sectional distal portion and cylindrical shaped portion of body 102 can be coupled or can be a unified structure. Square cross-sectional shaped distal end 104 may appear similar to a cargo carrier bar, as shown and described in U.S. Pat. No. 9,290,132.

FIG. 1C shows an example embodiment diagram 120 of a spare wheel adaptor bar for securing and transporting cargo with a body 102 extending through a spare wheel 122 from a side partial cross-sectional view. In various embodiments, a single piece or section of a SportHitch adaptor bar can be manufactured to have a body 102 with various different of lengths, as required for particular spare wheels and their spare wheel holders and based on vehicle type. As previously stated, plates 108 can be coupled between a vehicle and spare wheel 122. As shown, one or more bolts 118 can extend through orifices in mounting plate 108 and complementary shaped and located orifice locations in spare wheel 122. In some embodiments, plate 108 can be secured using a plurality of lug nuts, such as three lug nuts, that are normally used to secure the spare tire to its support structure, which is permanently coupled to the vehicle.

Further, as shown, body 102 can be a square or other cross-sectional shaped hollow tube or bar that extends posteriorly or distally through a middle hole 128 in the spare wheel and can have a length that ranges from about three to about nine inches, depending on the depth or width of the wheel and tire. In some embodiments, this range can be from about five to about ten inches, or others.

FIG. 1D shows an example embodiment diagram 130 of a spare wheel adaptor bar for securing and transporting cargo having a body 102 extending through a spare wheel 122 from a front view. As shown, bolts 118 can secure one or both of body 102 and spare tire 122 in place.

FIG. 1E shows an example embodiment diagram 140 of a spare wheel adaptor bar for securing and transporting cargo having a body 102 that is coupled with a mounting plate 108 from a side cross-sectional view. As shown, in various embodiments distal end 104 of body 102 can have an opening 124 that is operable to receive a cargo carrying bar in a hollow interior section of body 102. Grooves, notches, ridges, or other structures can be provided on one or more interior walls 126 of body 102 in order to help guide or otherwise strengthen coupling with cargo carrying bars. As shown, interior walls 126 of body 102 can also be reinforced or thicker near distal end 104 of body 102 to further assist in securing cargo carrying bars. One or more inserts 128, such as a Delrin insert, can be plastic, rubber, or other materials and can also help to secure the coupling of an inserted cargo carrying bar. This insert 128 can be permanent or removable and can be housed within a channel in the distal end 104 or within the interior of opening 124. As shown, he square, hollow distal portion 104 of SportHitch body 102 can have a plurality of holes 114, such as two side holes, used to secure the inserted SportBar with one or more pushbutton mechanisms of a carrier bar (e.g. see 216 of FIG. 2). A locking mechanism (not shown) of the adaptor bar body 102, the carrier bar, or both can also be provided in some embodiments and may be positioned to the side or otherwise adjacent to the pushbutton mechanisms or orifices 114.

FIG. 1F shows an example embodiment diagram 150 of a spare wheel adaptor bar for securing and transporting cargo having a body 102 that is coupled with a mounting plate 108 from a top-down cross-sectional view.

FIG. 1G shows an example embodiment diagram 160 of a spare wheel adaptor bar for securing and transporting cargo having a body 102 that is coupled with a mounting plate 108 from a front view.

FIG. 1H shows an example embodiment image 170 of a spare wheel adaptor bar for securing and transporting cargo having a body 102 with orifices 114 and 112.

FIG. 1I shows an example embodiment image 180 of a spare wheel adaptor bar for securing and transporting cargo having a body 102 with orifices 114 and insert 128. As shown, securing components 132 can extend partially or fully through complementary sized holes in body 102 and insert 128 to keep insert 128 in place with respect to body 102.

FIG. 2 shows an example embodiment image of a cargo carrier adapter bar device 200. In various embodiments, cargo carrier bars 200 can be used to securely transport and store cargo and other items. As shown, cargo carrier adapter bar device 200 can include a bar body 201 and at least one female receiver 201 for installation in a complementary sized hole of bar body 201. In the example embodiment, the female receiver 203 can be installed in bar body 201 such that the uppermost surface 202 is flush with a flat upper surface of bar body 201 and female receiver 203 can immobilize and support an item to be carried, with respect to bar body 201. In some embodiments, the female receiver 203 can be installed in the bar body with telescoping functionality, such that it is operable to move upward and downward with respect to bar body 201. This can allow the female receiver 203 to be adjusted upward and downward with respect to bar body 201 for carrying items and in order to provide compact storage and easy carrying.

In some embodiments bar body 201 can telescope directly out of a complementary hole in a trunk or other location in a vehicle wall or other surface. The female receiver 203 can have a narrow channel 204 for securing a complementary male component or portion that is removably or permanently coupled to an item to be carried or stored. Additionally, the female receiver 203 can have a wider opening section 206 such that a male portion can be inserted and slid into position in the narrow channel 204. Narrow channel 204 can be defined by sloped inner walls 208 that flare outward toward the bottom of narrow channel 204 and can match the sloped walls of the male section or component. When this recessed female trapezoid mount receiver 203 is utilized in carrier bar body 201, it can be oriented so that the wider section is closer to the rear of the vehicle at a proximal end 207. This can help keep the engaged male trapezoid and attached cargo abutted in the narrow channel when the vehicle is moving and also not require a separate vertical stop at end of carrier bar as a further safety mechanism.

Also shown in the example embodiment is a stopper 212 that can be shaped to fit within a complementary sized receiver hole 214 of female receiver 203, opposite narrow channel 204. As shown, stopper 212 can include an arm 216 whose distal end aligns with a proximal end of narrow channel 204. As such, the distal end of arm 216 can nearly or fully abut an end of a male trapezoidal mount when inserted within narrow channel 204. This can prevent movement of the male section with respect to the female receiver 203 when the stopper 212 is coupled with female receiver 203. In some embodiments, this can include a locking mechanism through a central portion of stopper 212 that turns or extends a second arm through a complementary sized slot in the side of receiver hole 214 to lock the unit in place during use.

Further shown in the example embodiment are buttons 216 on opposing sides of bar body 201 near the proximal end. In various embodiments, these can be pushed inward with respect to bar body 201 in order to slide within the body of a receiving bar or unit (e.g. within orifice 112 of FIG. 1H) and can then automatically pop out through orifices in the sides of the receiver (e.g. orifices 114 of FIG. 1H). These can be coupled with springs or other mechanisms internal to bar body 201 and provide a securing of adapter bar device 200 with the receiver. In some embodiments only one button 216 or more than two buttons 216 may be employed or provided.

Additionally, in the example embodiment is a proximal end unit 218. In the example embodiment, this is a generally cylindrical unit that can fit through a complementary sized hole in a receiver unit or at a receiving location. This can provide a further securing means. In some embodiments, a portion of proximal end unit 218 may screw off or otherwise decouple and be recoupled on an opposing side of a receiving wall. This can also include a locking mechanism in some embodiments.

FIGS. 3-5 show images of a spare wheel with central holes that can provide mounting locations for adaptor bars and adaptor bar receivers, such as those shown in FIGS. 1A-1I and 2, in order to carry cargo. Similar element numbers will be used for each of FIGS. 3-5 for the sake of simplicity.

FIG. 3 shows an example embodiment image 300 of a view of the rear end of a vehicle including a spare wheel 302. As shown in the example embodiment, a spare wheel 302 can include a central hole 304 that may be covered by a faceplate in some embodiments. This can receive an adaptor bar receiver or adaptor bar in various embodiments.

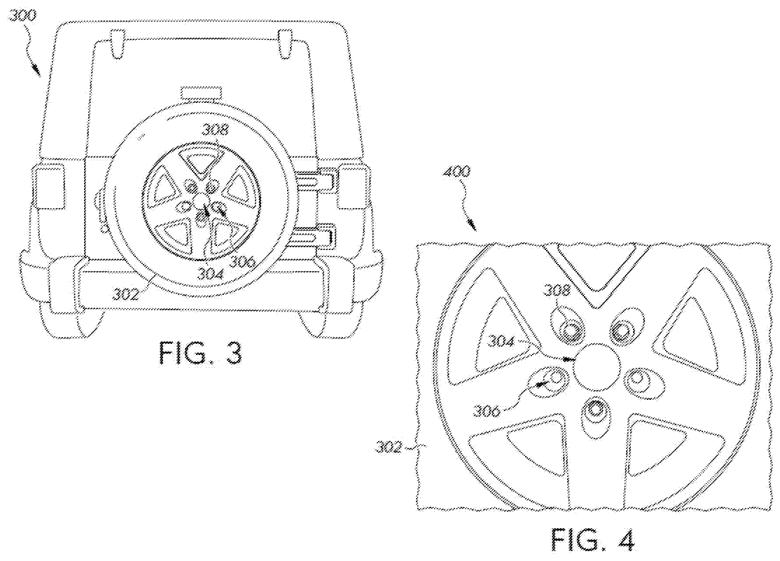

FIG. 4 shows an example embodiment image 400 of a spare wheel 302 of a vehicle with a circular central hole 304. As shown in the example embodiment, spare wheel 302 can include various bolt holes 306 that are operable to receive bolts 308 for securing the wheel 302 in place for transport, storage, or use in various embodiments.

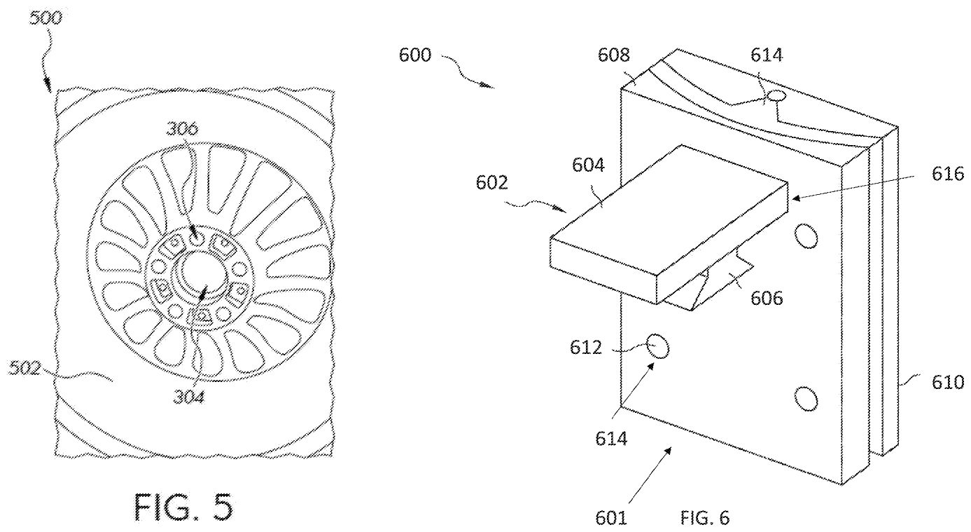

FIG. 5 shows an example embodiment image 500 of an interior of a spare wheel 302 of a vehicle with a circular central hole 304.

In some embodiments, a receiver unit can be located in a rear roof lid of SUV. As such, carrier bars may stair step downward to a main cargo carrier bar. Additionally, in some embodiments, this receiver unit can house a telescopic bar that automatically extends rearward with the push of a button out of a rear wall or other surface of a vehicle. Once the carrier bar is engaged in the outward position, the vertical bar can be attached to which the cargo carrier bar (e.g. 201 of FIG. 2) is attached.

FIGS. 6-10 show example embodiments of a male golf bag attachment that can be used to couple with a complementary shaped female receiver for carrying, transporting, and storing a coupled golf bag. Similar element numbers will be used for each of FIGS. 6-10 for the sake of simplicity.

FIG. 6 shows an example embodiment diagram 600 of a golf bag attachment 601 with a male attachment piece 602. The male attachment piece 602 can include a base 604 and a coupled male trapezoidal piece 606. In the example embodiment, the base 604 is oriented in a horizontal fashion such that the male trapezoidal piece 606 is below the base 604 but this can be oriented differently in different embodiments such as vertically or with the male trapezoidal piece 606 above the base 604. Male attachment piece 602 can be removably or permanently coupled with a mounting outer panel 608 that can be coupled with a mounting inner panel 610 by a variety of fashions. As shown, screws 612 are used, but clips, nails, bolts, and others are also possible. Outer panel 608 can be coupled with inner panel 610 using screws, nails, adhesives or other appropriate coupling mechanisms or combinations thereof.

As shown in the example embodiment, a male attachment piece 602 can be permanently or removably coupled directly to a golf bag or other items. In some embodiments, attachment piece 602 can be hinged at a location 616 by a bar or other pivoting mechanism, such that it can flip upward into a coupling position, operable to be engaged on a carrier bar. In hinged embodiments, it can also be flipped down and may be flush or otherwise somewhat adjacent to the outer panel 608 of a golf bag body when not in use. Suitcases and other items may have similar hinged mechanisms. Similar hinge mechanisms can be provided for various components in various embodiments. These may also be removable in some embodiments.

In some embodiments, a male or female attachment mechanism can be coupled to an electric, gas or manually dragged golf cart with a complementary shaped receiver or coupling location to easily carry the golf bag on a golf course.

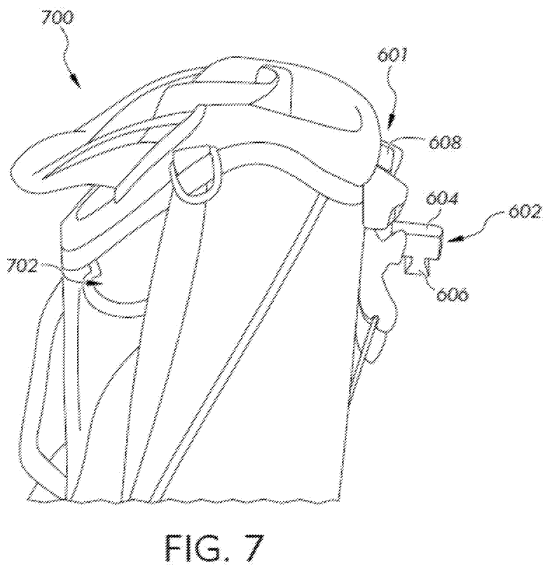

FIG. 7 shows an example embodiment image 700 of a golf bag 702 with a coupled attachment mechanism 601 from a side view.

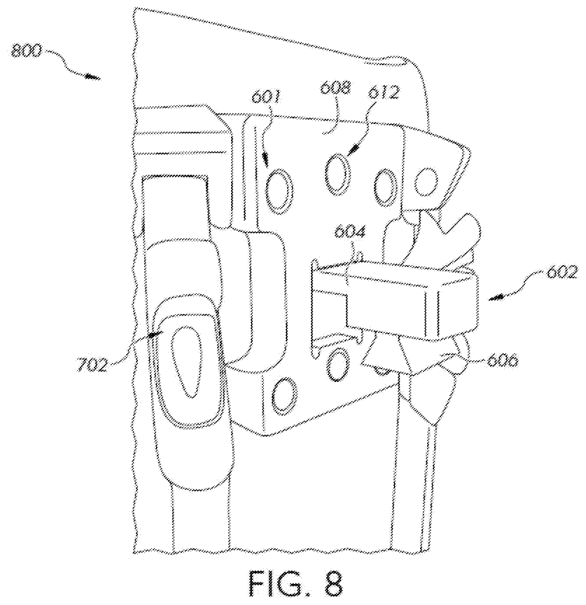

FIG. 8 shows an example embodiment image 800 of a close perspective view of a golf bag 702 with a coupled attachment mechanism 601.

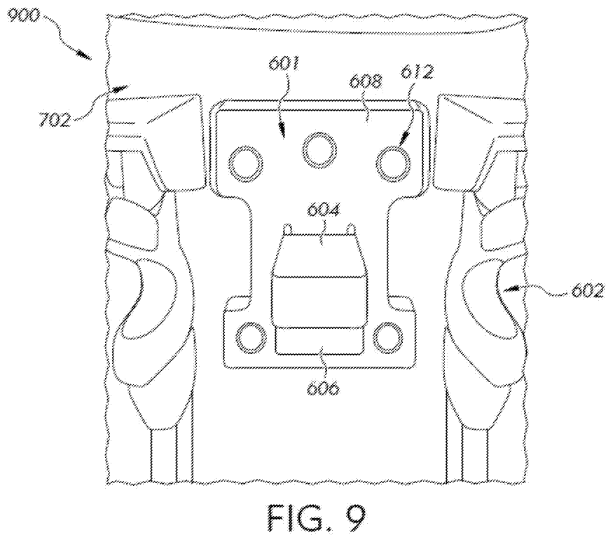

FIG. 9 shows an example embodiment image 900 of a close front view of a golf bag 702 with a coupled attachment mechanism 601.

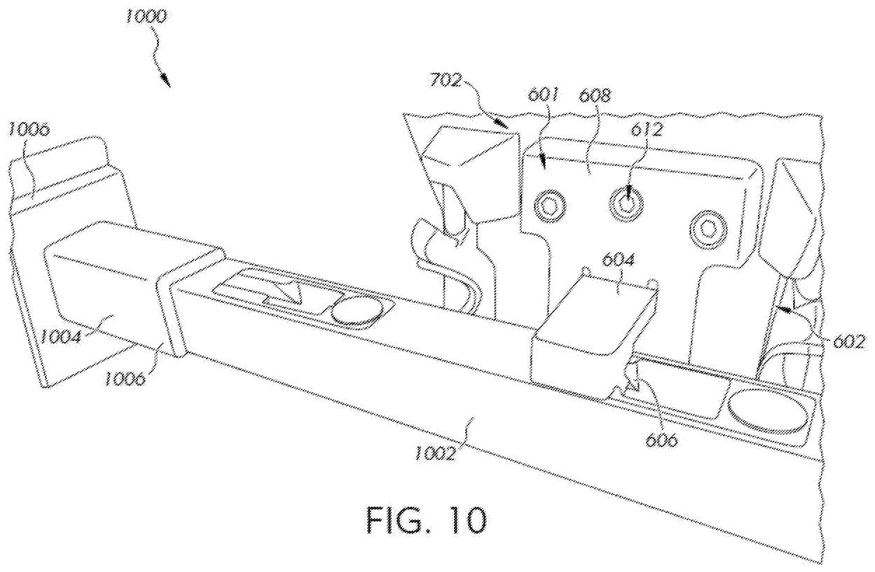

FIG. 10 shows an example embodiment image 1000 of a golf bag 702 with a coupled attachment mechanism 601 which is engaged with a cargo carrier and adapter bar device 1002 that is supported by a coupled receiver 1004. As shown in the example embodiment, initially, a receiver 1004, for storage or for support in transporting items, can be installed in a location by coupling or mounting a base plate 1006 in location using screws, bolts, nuts, or other coupling mechanisms as appropriate. An extension 1006 directed out of base plate perpendicularly can include a hole defined by at least one wall that is shaped to receive an end of a complementary shaped portion of a cargo carrier and adapter bar device 1002 (e.g. 201 of FIG. 2). This device can include one or more female receivers (e.g. 204 of FIG. 2) that are operable to receive a male trapezoidal piece 606 of an attachment mechanism 601 when inserted and engaged, in order to support, store, or transport a golf bag 702.

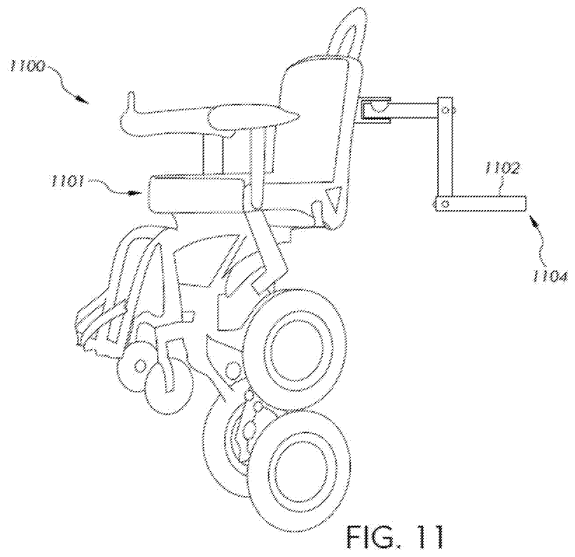

FIG. 11 shows an example embodiment diagram 1100 of an electromechanical human chair device 1101 coupled with a cargo carrier and adapter bar device 1102. As shown in the example embodiment, an adapter bar device 1102 can include a proximal end 1104 that can be coupled with or otherwise attached to a vehicle for transport or fixed location for storage purposes. In the example embodiment, adapter bar device 1102 has three separate sections, two horizontal and one vertical section coupled therebetween to each, in order to support the chair device 1101 at an appropriate height above a ground or other lower surface.

To further elaborate, in some embodiments, chair devices 1101 can be powered “smart wheelchair” or other electromechanical human chair devices can have remote and automatic controls. These can include mechanisms to provide a user in a vehicle's driver seat the ability to stay in the seat while the chair engages or disengages from a rear area of a vehicle, such as when carried and transported using attachment bars 1102. When not engaged, the chair 1101 can then back up to a carrier bar 1102 that is coupled with a vehicle and secure iteself to to the carrier bar 1102 using a coupling mechanism of the carrier bar and a complementary mechanism that is coupled with the chair 1101. For example, these can be male extensions and female receivers as described herein. As such, chair 1101 may be able to automatically or remotely lift itself upward, such as the example of Dean Kamen's iBOT wheelchair, which may then engage and couple with the carrier bar 1102. Once engaged, preferably after the user has been safely transferred out of the chair, chair 1101 may lift its wheels up off the ground and be in a transportation ready position. In some embodiments the wheels may be locked in place. Some electromechanical or powered chairs, as shown in the example embodiment, may require a vertical extension bar of bar 1102 to lift them upward before engaging a carrier bar 1102 and may require external power to raise the chair 1101 once the extension bar 1102 is engaged and coupled. Currently, the iBOT is operable to rise about twenty inches, more than the about fifteen inches of ground clearance required for normal cargo carrying to be safely accomplished during transportion by a vehicle. IBOT wheelchairs currently weigh about three hundred pounds. As such, carrier bars 1102 and their associated mechanisms in various embodiments are operable to securely carry at least that amount of weight and generally more.

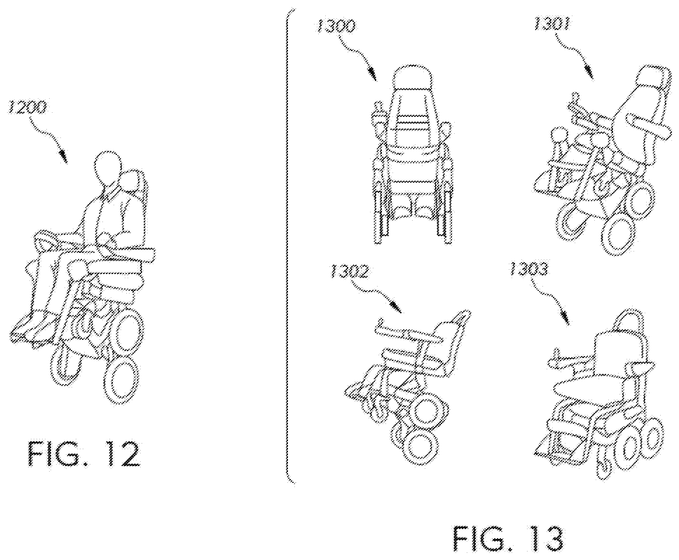

FIG. 12 shows an example embodiment image 1200 of an electromechanical human chair device 1202 for coupling with a cargo carrier and adapter bar device.

FIG. 13 shows example embodiment images 1300, 1301, 1302, 1303 of an electromechanical human chair device for coupling with a cargo carrier and adapter bar device from various perspective views.

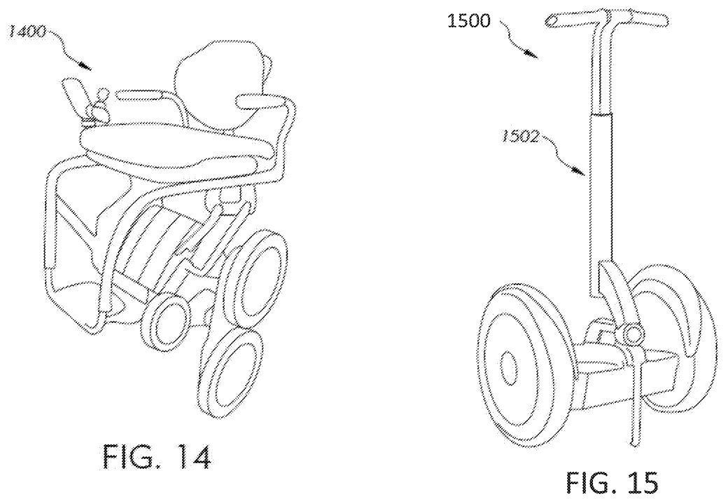

FIG. 14 shows an example embodiment image 1400 of an electromechanical human chair device for coupling with a cargo carrier and adapter bar device.

FIG. 15 shows an example embodiment image 1500 of an electromechanical human standing transportation device 1502 for coupling with a cargo carrier and adapter bar device. In the example embodiment, users generally stand on a platform of the standing device 1502 and hold on to one or more handlebars that extend outward to the sides of a vertical bar. In the example embodiment, a male extension or female receiver can be coupled with device 1502 at an appropriate location for coupling, transportation, and storage by a cargo carrying and storage bar. This can be on a side of the vertical bar, an extension therefrom, or at a handlebar location. In some embodiments, this can also be near the platform or one or more wheels.

To elaborate, as shown in the example embodiment, a standing human transportation device 1502, such as a Segway, generally weigh about ninety-five pounds. These devices can be adapted to be coupled with and transported by carrier bars automatically or manually and engaged. In some embodiments, a square hole an be manufactured in a cross-section of a horizontal handlebar of the transportation device, with a vertical telescopic bar. This hole can then be slipped over or otherwise coupled with a carrier bar and secured with an attachment or coupling mechanism. It may also be placed or otherwise positioned on a carrier bar sideways in some embodiments, with other attachment mechanism adaptors. These vertical telescopic bars can be modified to include a motor that lifts it's wheels off of the ground, once it's handlebars have been engaged with the carrier bar. In some embodiments, the vertical section of the transportation device 1502 can be adjusted to shorten or lengthen its overall height, as appropriate.

FIG. 16 shows an example embodiment image 1600 of a bottle carrier device 1602 with attached cargo carrying adaptor 1604. As shown in the example embodiment, carrier adaptors 1604 can be female and can be coupled with numerous cargo carrying attachments, here a water bottle holder 1602. In other embodiments, carrier adaptors can be male. A complementary device for the male or female adaptor 1604 can be coupled with a bicycle or other device, item, or location in order to provide a mounting location for supporting the water bottle holder 1602 during transportation or storage. As shown, coupling between water bottle holder 1602 and one or more surface of adaptor 1604 can be achieved using welds, adhesives, glues, clips, latches, nuts, bolts, screws, clasps, or others in various embodiments. In some embodiments, these may be removable or permanent and may be oriented in a variety of fashions.

In some embodiments, a tightly connected rotating base can include opposing ridges, in order to maintain the base in a desired angle of rotation on the adaptor 1604, either a female or male attachment mechanism. This may be desired or advantageous in some embodiments, such as where an attachment is located on a baby stroller or belt to which a water bottle may be attached at different angles.

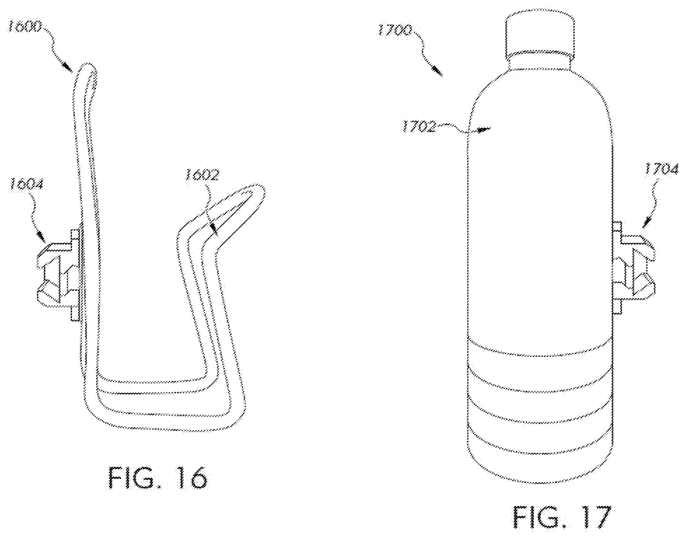

FIG. 17 shows an example embodiment of a bottle 1702 with attached cargo carrying attachment 1704. As shown in the example embodiment, cargo carrying attachment 1704 can be permanently or removably coupled with various items, here a water bottle 1702. Similar principles apply to attachment 1704 as 1604, as appropriate. It should be understood that bottle 1702 could be any item and is not limited to a water bottle in various embodiments.

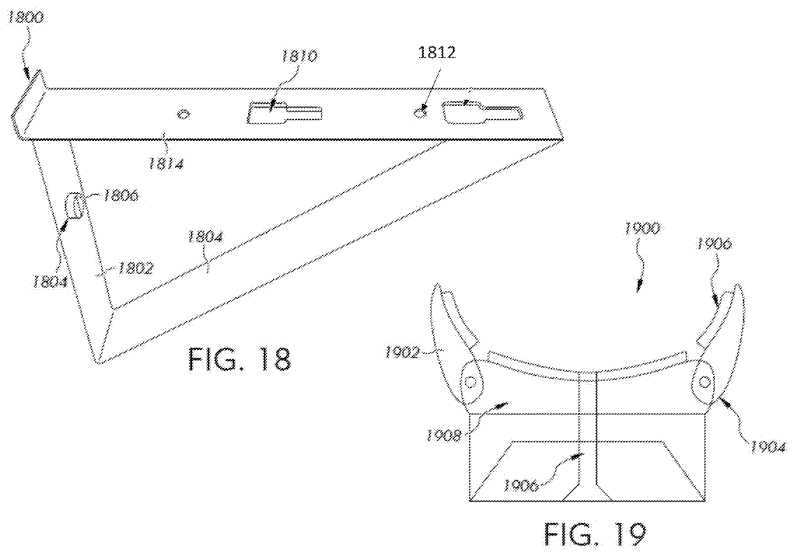

FIG. 18 shows an example embodiment of a wall mounting 1800 for a cargo carrying and storage device. As shown in the example embodiment, a wall mounting 1800 can include a base plate 1802 that can be generally vertical and installed flush against a wall by inserting one or more screws or bolts 1806 through one or more holes in mounting plate 1804 to fix it in position. A supporting surface plate 1814 can extend horizontally from at or near the top of the mounting plate 1802 and meet an angled lower support structure 1804 near an end opposite the mounting plate location. As shown, angled lower support structure 1804 can extend at an angle upward from at or near the bottom of mounting plate 1802 to a location at or near the end of supporting surface plate 1814. In some embodiments, each of 1802, 1804, and 1814 can be a single unified structure. As shown a female receiver hole 1810 of appropriate dimensions can extend through supporting surface plate 1814 and receive a male extension of an item or bar to be supported. One or more additional holes 1812 can add an additional securing means for bars or other items. Thus, wall mounting 1800 can be used for supporting items during storage and can include holes for male attachment mechanisms to be inserted and slipped into position.

FIG. 19 shows an example embodiment diagram of a cargo carrier device 1900 with hinged wings 1902 from a side, partial cross-sectional view. As shown in the example embodiment, attachment mechanisms 1900 having hinged wings 1902 can include adhesive or frictional surfaces or couplings 1906 on their inward facing surfaces for securing cargo. In some embodiments, this can be tape, such as VHB tape, that is coupled with the one or more “wings” 1906, which are coupled to a body 1908 at hinges 1904 that are operable to fold or otherwise securely grip cargo or sections of cargo, bars, or other items. In some embodiments, wings 1902 pivot inward about hinges 1904 and can be locked or otherwise secured in place. As shown, body 1908 can include one or more mounting holes 1906, through which a screw, bolt, or other securing mechanism can be used to couple it with an item.

In some embodiments, cargo carrier device 1900 can be permanently secured to an item or in a location using mounting hole 1906. For example, it may be securely coupled with a male or female mount. As such, a bar or other structure of a device to be carried can then be supported and removed easily using cargo carrier device 1900. In other embodiments, cargo carrier device 1900 can be removably coupled with all items. For example, it could be removable coupled with both a bar or other structure of an item to be carried and with a male or female coupling structure.

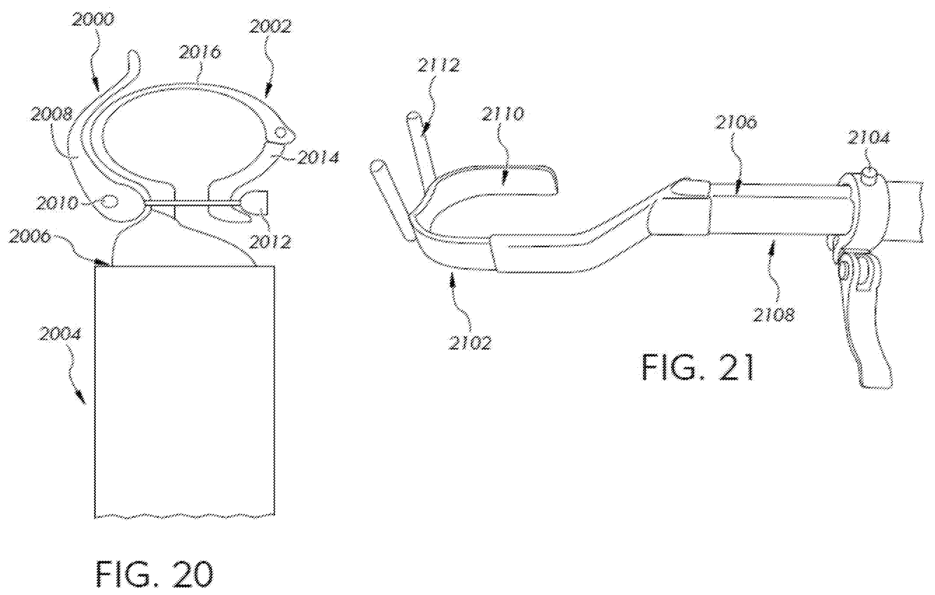

FIGS. 20-21 show example embodiments of end sections and FIGS. 22-23 show a whole adaptor bar for use on a bicycle that can be removable, adjustable horizontal support adaptor bars. Some modern bicycles are constructed in a fashion such that they do not have a horizontal bar between the user's legs extending from below the handlebar area to a vertical bar underneath the bicycle seat. These types of bicycles can have other configurations with a bar such as angled bar extending downward and not directly horizontal. As such, a removable, adjustable horizontal support adaptor bar can be used for such bicycles to provide a location for carrying the bicycle on a carrier bar as described herein using a male/female connection system, also described herein.

As shown in FIG. 20, an example embodiment a posterior end diagram 2000 of an adaptor bar can include a clamp 2002 that is removably or permanently coupled with a bar body 2004. Clamp 2002 can be generally circumferential, such that it can hold a bar of a bicycle in a central hollow location or area. It can include one or more arms 2008 that are releasable and fixable about a pivot 2010 with respect to the clamp, in order to hold the clamp tight. Further, a releasable pin 2012 can be inserted through a hole in a hinged arm 2014, through a hole in clamp body 2016 and extend into a hole near hinge 2010 to secure arm 2008.

In some embodiments, a hinge (obscured) may or may not be included at a location 2006, such that a clamp can be fixed or moved to a slight angle from a horizontal plane that is parallel with a ground surface in use. This angle, for example, can be about 15 degrees from a horizontal plane. It can be various other angles in varying embodiments and in some embodiments the hinge may be movable, rotatable using a ball in socket connection, and fixable.

To elaborate, in the example embodiment a removable, extendable horizontal support adaptor bar body 2004 is shown. Clasp 2002 is shown at one end of the support bar body 2004, which can be placed around the vertical bicycle seat support bar. This clasp 2002 can be tightened using ratcheting mechanisms, screwing mechanisms, or various other appropriate tightening and securing components. Additionally, an interior surface of the clasp body 2016 and arm 2014 can include rubber or other pliable material which will not cause harm to the vertical bicycle seat support bar and provide a tight seal between the clasp and the vertical support bar. The clasp 2002 can be coupled with a first bar sleeve 2004 by a hinge which allows for rotation about the hinge in a vertical, horizontal, or multiple planes. This hinge can be useful in instances where the vertical bicycle seat support bar is not perpendicular with a flat ground surface and allows the removable, adjustable horizontal support adaptor bar body 2004 to be configured such that it is parallel with a flat ground surface or other desired angle. A lower surface of the first bar sleeve can include a male component as shown in the example embodiment or with a female component in alternate embodiments. Additionally, the first bar sleeve 2004 can include a securing mechanism, on an upper surface of the first bar sleeve. This securing mechanism can be used to secure the first bar sleeve with a male interior bar.

As shown in FIG. 21, an example embodiment of an anterior end image 2100 of an adaptor bar can include a hooked arm 2102. As shown in FIG. 21, a notch or groove 2106 can be provided in a male arm 2108 that is coupled with hooked arm 2102 to provide an additional mating surface with a bicycle bar.

In the example embodiment, a securing mechanism 2104 is a rotatable screw which can be twisted into place through mated grooves in a screw hole in a first bar sleeve, which can be a female receiver bar sleeve (e.g. 2004 of FIG. 20). In the example embodiment, the male interior bar 2108 can have a hook at one end which can be wrapped around a vertical handlebar support post. In various embodiments, a rubber or other gripping surface can also be provided on the inner surface 2110 of the hook. A hook looping mechanism 2112 can be provided on an upper surface of the hook 2102 and can have the shape of a Texas Longhorn horns or simple upward vertical extensions as shown. These can engage an anteriorly projecting handlebar post. The hook looping mechanism 2112 can provide two locations (one on either side of a handlebar support bar) at which a rubber strap, thread or other securing component (not shown) can be wrapped in order to hold the hook 2102 in place.

FIGS. 22-23 show example embodiments of an adaptor bar device 2302 with a clamp at one end and a hook at the other from a side view image 2200 and top view image 2300, respectively. Similar numbering will be used for each. As shown in the example embodiments, a clamp 2202 can have a generally U-shaped, V-shaped, rectangular shaped, irregular shaped, or other shaped interior space that can slip around and be coupled with a bike seat post such that it mates with a bar of the bike seat post. This clamp 2202 can have a securing cam lock 2304 in various embodiments. As such, if a securing cam lock breaks or is otherwise lost, damaged or manipulated, the Adaptor Bar 2302 can still remain coupled to the seat post. Therefore, if the Adaptor Bar 2302 is attached to a bicycle, the bicycle will not fall of the Adaptor Bar 2302 during transportation or storage. The securing cam lock 2304 may operate in similar fashion to other mechanisms with which bike owners are already familiar. Although removable and adjustable in some embodiments, adjustable support Adaptor Bar 2302 is shown in a horizontal orientation and has a square, rectangular, or cylindrical sleeve 2204 and male interior bar 2208 components with a square, rectangular, or circular cross section. Internal and external sleeve components can include a cam lock 2306 to secure the telescoping components in place. These can be removably secured using various tightening mechanisms using pins, screws, turn knobs or others. In should be understood that these could also have triangular or other cross-sectional arrangements in various embodiments. Additionally, in some embodiments the removable, adjustable horizontal support adaptor bar can be installed in an opposite orientation with a hook mechanism 2310 coupled to a vertical bicycle seat support bar and a clasp mechanism coupled to the vertical handlebar support bar. As shown in FIG. 22, a male attachment 2312 can be removably or permanently coupled with an outer sleeve 2204 in order to allow a bicycle to be safely and securely transported or stored, and/or to safely and securely transport and store items when the bicycle is in use.

FIG. 23 shows an example embodiment of a top view of a removable, adjustable horizontal support adaptor bar 2302. In the example embodiment, clasp 2202 can be a quick release mechanism. Although not shown in the example embodiment, if provided, a hinge can be clicked and allow pivoting in only one plane thus allowing hook to move up and down to engage handlebars. A male or female coupling piece or mechanism can be located in a most likely center of gravity or mass zone such as nearer to a seat, as shown in FIG. 22 with male attachment 2312. Male interior bar 2208 can include a slat of metal or other material behind hook in order to maintain it in position against vertical bar. In some embodiments, clasps such as clasp 2202 can be used on both ends of the removable, adjustable horizontal adaptor bar 2202. Likewise, in some embodiments, hooks 2310 with securing mechanisms 2314 can be used on both ends of the removable, adjustable horizontal adaptor bar 2302 and extend upward in a vertical manner therefrom. Coupling mechanisms 2314 can be plastic, have rubber coverings, rubber inserts, soft synthetic materials, cloth coverings and can provide shock absorption and protection for any bars they may be mounted to. Coupling mechanisms 2314 can be coupled with themselves, each other, or with other structures using straps (not shown) that may have a loop at one or both end and may be oriented around one or more portions of a bicycle in various embodiments.

Coupling mechanisms 2314 can also be attached to the clamp, such that they operate as a double clamp that accepts a male trapezoid coupling mechanism extension to secure the sleeves and secure to a coupling location at same time.

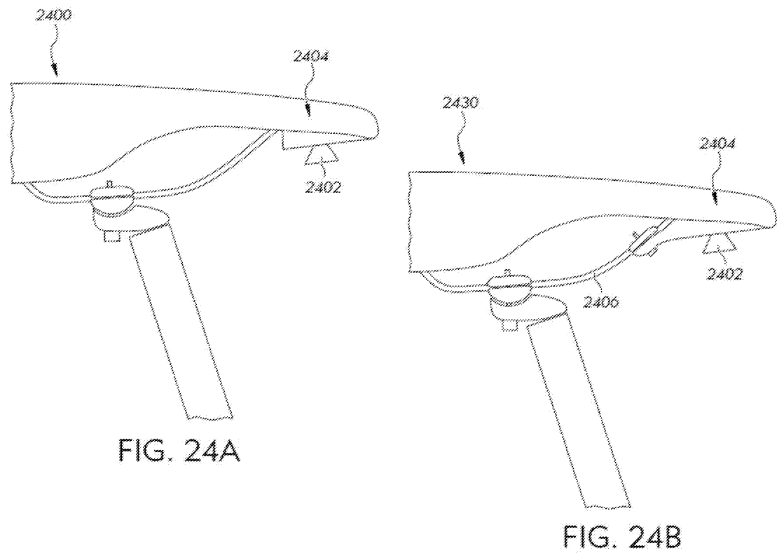

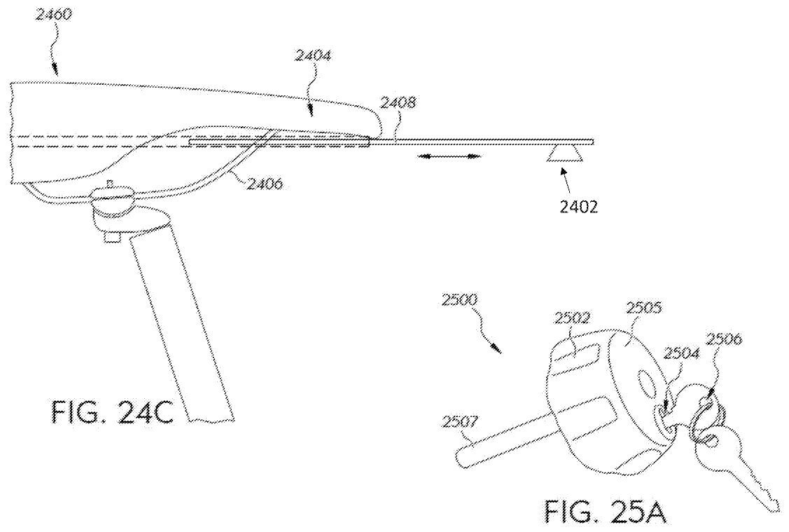

FIGS. 24A-24C show example embodiments diagrams 2400, 2430, 2460 of bicycle carrying apparatuses.

As shown in FIG. 24A, a male coupling mechanism 2402 can be permanently or removably coupled or attached directly to the underside of a front end of a bicycle seat 2404 as part of an original manufacture or aftermarket with screwing, bolting, or other mechanisms as appropriate, some with additional mounting plates. Although this is not at the CG (Center of Gravity) of the bicycle, in some embodiments it provides adequate support.

As shown in FIG. 24B, a male coupling mechanism 2402 can be permanently or removably attached and secured to one or two bars 2406 that are common to most bicycle seat 2404 undercarriages and therefore can be added to nearly any bicycle seat 2404. In some embodiments, these can be attached to bars 2406 with a similar clamp to the clamp mechanism attaches to a bike post, or with screwing, bolting, or other mechanisms as appropriate.

As shown in FIG. 24C, an extension kit can be attached to the underlying support bars 2406 of the seat so that the male trapezoidal mechanism can extend forward through a telescoping or track mechanism 2408 for a distance, in some embodiments about 5 inches, to reach the CG of the bicycle. The mechanism 2408 can then be locked in place with respect to bars 2406 a screw, cam lock or inter digitizing teeth. In some embodiments, the extension kit can be attached to two under-seat bars 2406, to the main bar, to the front bar, or combinations thereof of a bicycle. In some embodiments, they can extend the whole length of the bicycle between posts.

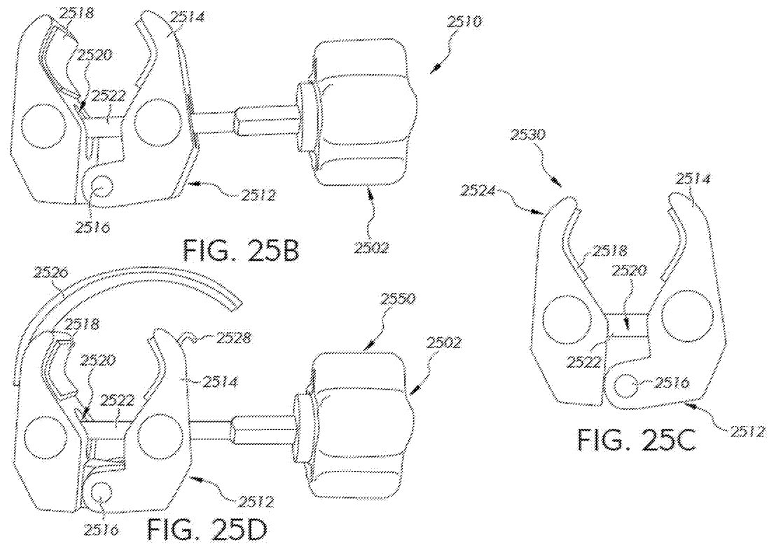

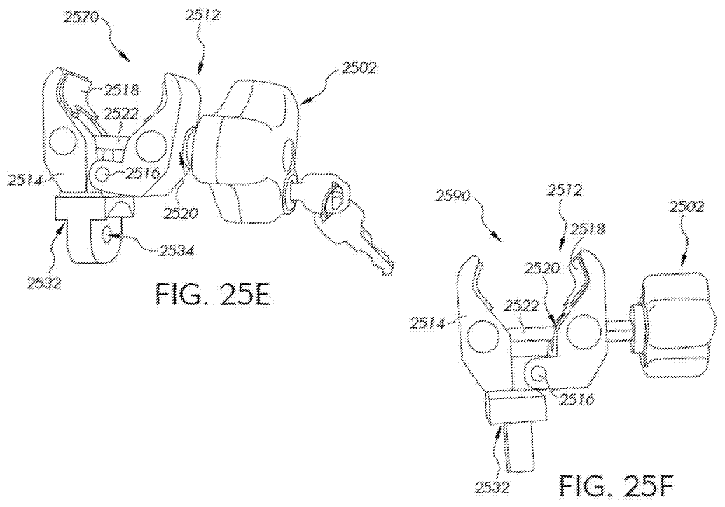

FIGS. 25A-25F show example embodiment images 2500, 2510, 2530, 2550, 2570, 2590 of a lockable clamp and knob for use with a bike seat post. Each of FIGS. 25A-25F will be described in turn below but in general, as shown in the example embodiments, a lockable clamp that can be coupled with a bicycle seat post can include a keyhole allowing for insertion of a key to lock and unlock the clamp. In various embodiments, the key can allow for a lockable turn knob having the keyhole and internal components that is coupled with or otherwise built into the clamp to screw together a threaded post with a compatibly threaded hole such that the threads are directed for clamping more quickly than prior art clamps. As such, this configuration of threading can cause opposing arms of a clamp to tighten more quickly than previous clamps. In some embodiments, this can be twice as fast as previously known with each successive turn of the associated knob.

As shown in FIG. 25A, a knob 2502 can include a keyhole 2504 for securely accessing and using a clamp, locking it in position using a key 2506 and other features. This knob 2502 can include a handle or head piece 2505 with one or more grip promoting features, such as ridges, grooves, textured surfaces, or others. Head piece 2505, can be coupled with a centrally located threaded post 2507 for mating with and securing complementarily threaded holes.

As shown in FIGS. 25B-25F, a clamp 2512 can include one or more movable arms 2514 that are joined at a hinge 2516. Although the hinge 2516 shown is located at an end of each arm 2514, in various embodiments it can be located at an appropriate location that is not located at an arm end. Each arm 2514 includes can include a gripping section or feature 2518 along an interior surface that can also include one or more features to promote gripping a bicycle or other post. These features 2518 can be rubber or other materials in various embodiments and can be affixed with one or more adhesives, screws or other attachments. Each arm 2514 may have a gripping feature 2518, shown as pads, or only one may have these features. In embodiments where each arm 2514 has features 2518, they can be located directly in opposition and facing each other or they can be located at irregular angles with respect to each other. A hole 2520 in one or both of the arms 2514 can be threaded to receive a threaded post 2522. Turning the post 2522, for instance by turning a handle of a knob 2502 that can be coupled with the post, can cause movement of one or both of the arms 2514 towards or away from each other depending on the direction the knob 2502 is turned. In some embodiments, the knob 2502 and post are removable from one or both of the holes, while in other embodiments, the knob 2502 and post are not removable. In some embodiments, extensions 2524 can be provided at the ends of one or both 2514 arms to lengthen them. In the example embodiment, two extensions are shown, each about 0.5 millimeters long.

As shown in FIGS. 25B-25F, the threaded post 2522 can have differently oriented threads at a distal and proximal location along its length in some embodiments. It should be understood that complementary oriented threading is to be used in order for operability in each arm 2514. This can provide the enhanced speed affect when turning the knob 2502 in various embodiments. In some embodiments, the knob 2502 can be removable from the post.

As shown in FIG. 25D, some embodiments can include a safety strap, arm, or extension 2526 that is coupled with one or more clamp arms 2514. In some embodiments, this extension 2526 can be removable while in others it can be permanently affixed to one arm 2514. A secondary clasp 2528 can be used to secure the strap, arm, or extension 2526 to the second clasp arm 2528 in some embodiments, while in others it can be secured directly to the second arm 2514. The strap arm or extension 2526 can be independently adjusted in some embodiments, while in others its movement may be dependent on that of an arm 2514 it is affixed to or dependent on movement of the knob 2502 and threaded post 2522.

FIGS. 25E-25F shows an example embodiment of two removal and lockable clasps 2512. As shown in the example embodiment a permanent or detachable back end piece 2532 can be attached near a hinge 2516 on a side opposite the area between arms 2514 and can include a hole or holes 2534 that can be threaded or otherwise coupleable to other features in various embodiments.

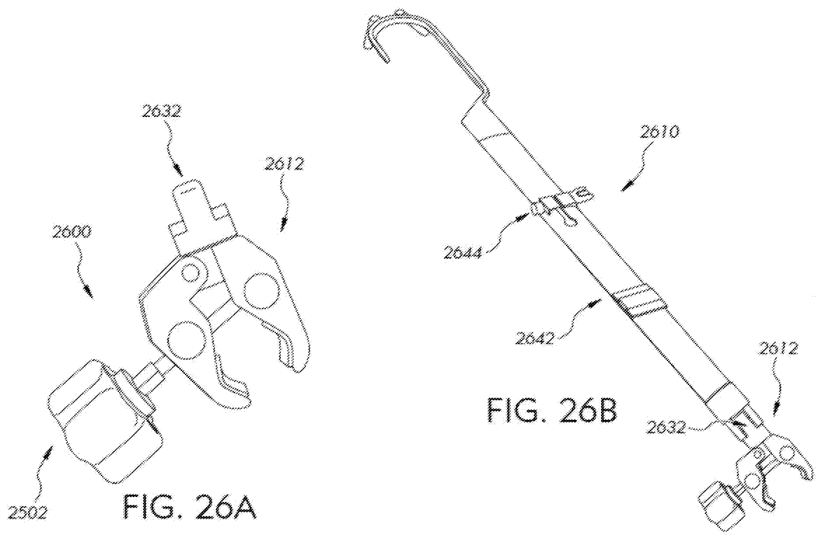

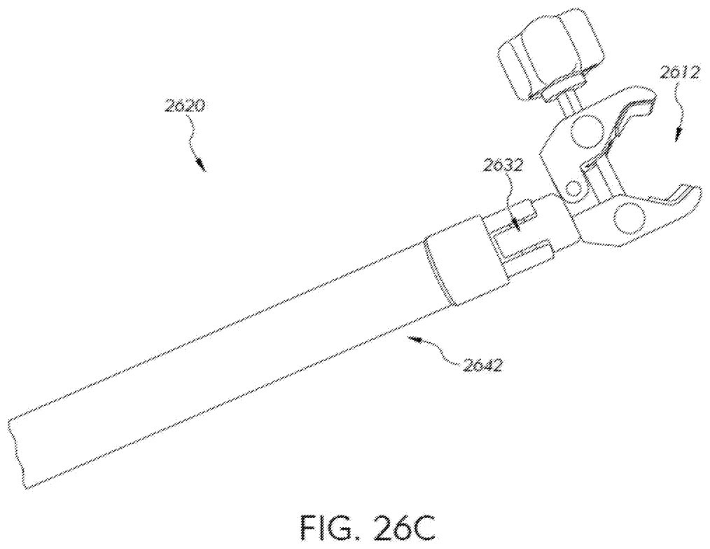

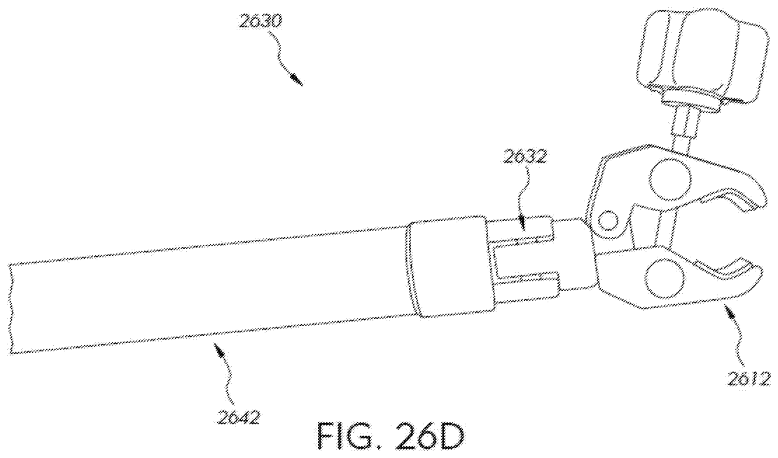

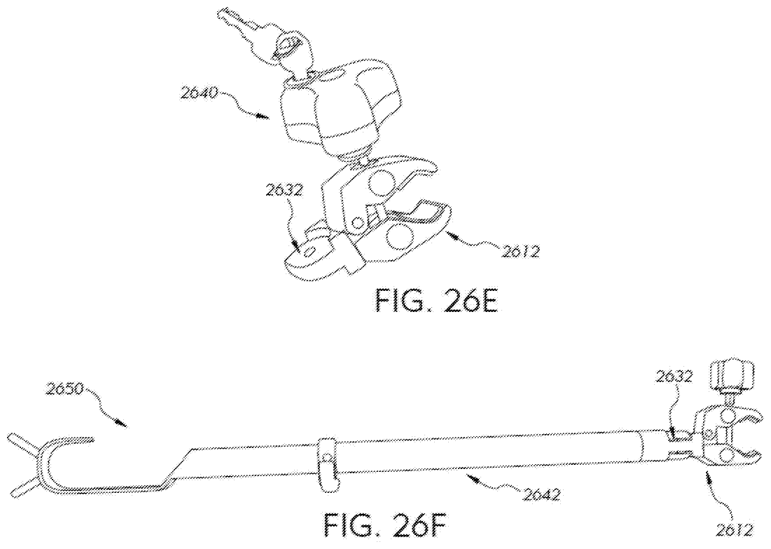

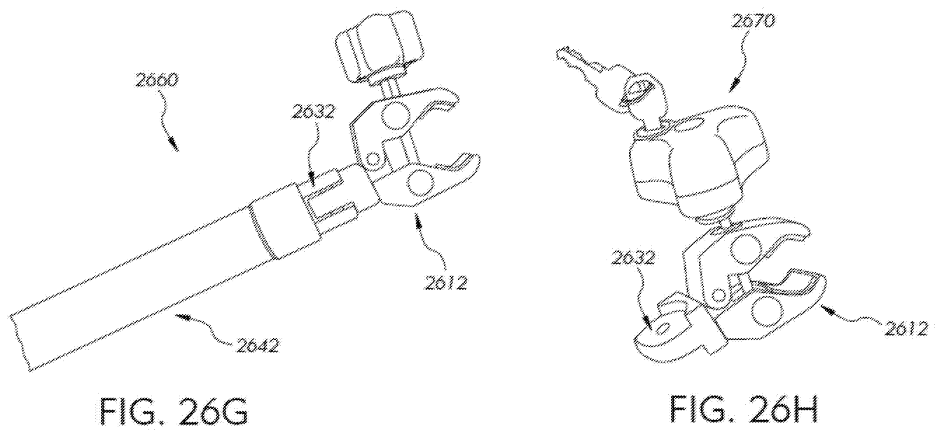

FIGS. 26A-26H show example embodiments of adaptor bars with removable clamps 2600, 2610, 2620, 2630, 2640, 2650, 2660, 2670. As shown in the example embodiment, the clamp 2612 can be used to secure adaptor bars 2642 (e.g. 2302 of FIGS. 22-23) at one or both ends to bicycle posts by securing the clamp 2612 that encircles part or all of a seat post or handlebar post. As described herein, the securing mechanism 2644 that secures the two telescopic tubes of the adaptor bar can be a screw mechanism, or a cam lock mechanism.

As shown in the example embodiment a permanent or detachable back end piece 2632 can be attached include a hole or holes 2634 that can be threaded or otherwise coupleable to other features in various embodiments. Here, they are used to allow a bar (obscured) to secure back end piece 2632 to an end of adaptor bar 2642 in a space between two extensions of the bar that each have holes or locations to secure the bar.

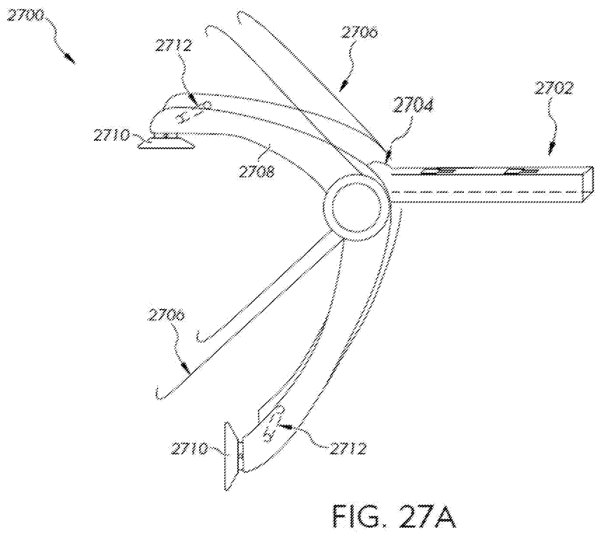

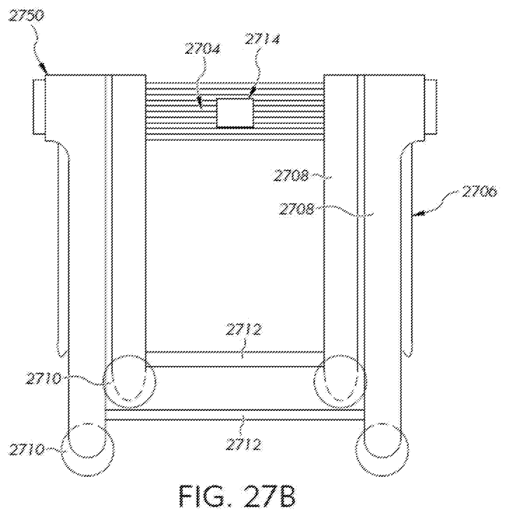

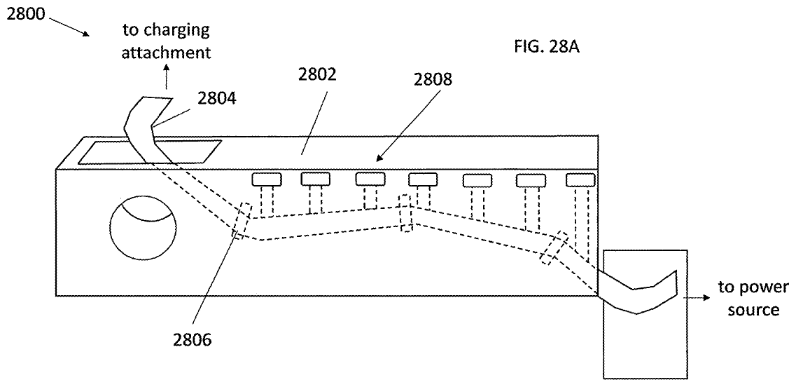

FIGS. 27A-27B show example embodiment diagrams 2700 and 2750 of a carrier bar and support system, including components for coupling with the rear of a vehicle, from a side view and front view, respectively. Included are one or more carrier bars 2702 having carrier components that can have a substantially horizontal orientation in a carrying orientation. These bars 2702 can be removably or permanently coupled with one or more posts 2704 perpendicularly oriented in a generally horizontal direction parallel to a ground surface. Also included are one or more retaining straps 2706 that can be strapped to or around a trunk lid that are coupled to the perpendicularly oriented post or bar 2704. Additionally, one or more arms 2708 can be coupled to the perpendicular oriented bar 2704 that can rest on or be coupled with a rear or upper surface of a trunk lid, or both in some embodiments. These couplings can be mechanisms 2710, such as suction cups-like, and can be secured in place by a manual suction cup near the end of each arm. In some embodiments, secondary bars or straps 2712 can couple bars together for added securing.

As shown in FIG. 27B, a storage orientation can allow for removal and decoupling of the one or more carrier bars from a slot 2714 and arms 2708 can lie flat with respect to each other.

It should be understood that as described in herein, a transitional carrier bar or portion of the bar, having a female or male trapezoidal mounting can be attached to or otherwise coupled with an adaptor that is affixed or removably coupled with a vehicle or in a fixed location. These can include attachment of the transitional carrier bar to a tow hitch, a roof rack, a trunk rack, any other rack or surface appropriate to attach the transitional carrier bar. In some embodiments, trunk racks may require straps or other secondary components. In some embodiments, these may be inside a trunk, particularly for smaller sized embodiments. Likewise, it should be understood that female or male trapezoidal mountings can be directly or indirectly coupled with various existing rack systems and other surfaces using appropriate coupling means as described herein or later developed.

In some embodiments, receiving holes in a rear surface of a trunk lid can be standardized for a standard receiver unit and may accept and engage a primary carrier bar. One or more of these holes can be covered with standardized automaker emblems that are pre-configured to attach to a standardized opening mechanism.

A receiver unit can also be stabilized internally by a variety of laterally, vertically and anteriorly directed support bars that have been tailored or customized to one of a variety of different trunk lid shape, size and configuration. This can be similar to the tailoring of different cargo support bars for various vehicles that are produced to attach standardized tow hitches to a variety of motor vehicles.

In some embodiments, a primary carrier bar inserted into a receiver mechanism can be automatically locked with a latch type mechanism, similar to those found in vehicle doors, either remotely or locally. These springing latches can be part of a receiver unit (on an inferior side of the receiving unit) and may spring into a receiver unit opening. When a primary carrier bar is inserted, it may push the latch outward. Then, when the latch contacts the inferiorly oriented opening in the carrier bar, it can spring into the hole and secure the carrier bar in place. The latch can later be released automatically or manually by opening a locked trunk lid and manually or automatically releasing it using an appropriate release mechanism.

In some embodiments, carrier bars can be coupled with the front or rear surfaces of buses or other vehicles and can include hinges, such that they can be rotated outward from a flush position. In some embodiments, receiver units can be easily attached to a rear surface of car, pickup or other truck, sport utility vehicle, all-terrain vehicle (ATV), recreational vehicle (RV), motorcycle, boat, or other vehicle, such as using a plurality of bolts (e.g. with four bolts), in an aesthetically pleasing manner. In some embodiments, carrier bars, adaptor bars or storage bars can telescope, be hinged in a double hinge or provide other convenient storage operability for users.

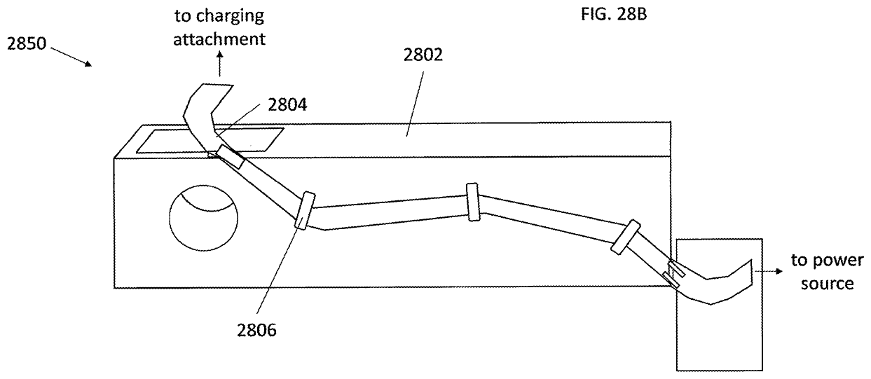

FIGS. 28-31 show a variety of embodiments for electrical, magnetic, and electro-magnetic systems or sub-systems can be coupled or integrated with carrier or storage bars and also with any associated trapezoidal or other shaped mounts, as appropriate. As such, electrical, magnetic, and electro-magnetic systems or sub-systems can be aftermarket or off-the shelf pre-installed. These systems or subsystems can be installed by users or manufacturers on a variety of existing and later developed storage or carrier racks, bars, devices, apparatuses, and the like. They can power individual locations or parts of these devices, or the devices as a whole. In general, they can be used to power or charge batteries for electrical bicycles, wheelchairs, scooters, grill plates, refrigeration units, lights, sound systems with speakers, televisions, computers, or any of a variety of other electrically powered vehicles or items. Power for these systems can be provided by or drawn from a vehicle's or a building's normal electrical system, from independent batteries, or in other appropriate manners. As such, appropriate wiring and any associated coupling mechanisms are contemplated. These electrical systems can be removable or permanent in various embodiments.

In some embodiments, wireless or cordless electrical charging systems can provide charging by induction. Those in the art will understand that separate electrical coils can provide charging wirelessly by powering one of the coils and moving the other within its proximity in a correct orientation.

FIG. 28A shows an example embodiment 2800 of a carrier bar 2802 with internal electrical wiring system. As shown in the example embodiment in some of these electrical systems, wiring 2804 can be provided directly through the body of a carrier bar 2802 and subsequently through a trapezoidal or other shaped mechanical mount. Here, an electrical wire 2804 is shown as threaded through a hollow interior of a carrier bar, which can then be threaded through additional carrier or storage bars or racks or sections thereof. The solid portions of the wire are shown outside of the body of the carrier bar and the dashed sections are internal to the carrier bar. In various embodiments, wiring can be removably or permanently coupled to internal carrier bar surfaces using adhesives, clips, or other mechanisms 2806. As shown, one or more charging ports 2608 can be provided on one or more surfaces of the carrier bar and electrically coupled to a power source. These can be any of a variety of types of receivers, aside from the USB type ports shown. These could also be plugs in some embodiments, while some embodiments can have both plugs and receivers. A plug or receiver can also allow a charging attachment to be coupled to the power source, such as a mounting attachment or receiver, which may be trapezoidal in cross-sectional shape. A variety of coupling mechanisms are also shown with dashed outlines to indicate that they are internal to the bar. In some embodiments, integrated loops can be provided on or in the carrier bars to thread wiring through, which are slightly larger than the exterior dimensions of the wires.

As such, the mount itself provides the electrical charging ability when it is coupled to a contemplated component and power is turned on. In some embodiments, separate wiring and plug couplings can be provided, such that the mount itself does not provide the electrical charging. This electrical wiring associated with the carrier bar can require one or more electrical contact points or connections that automatically couple the automobile or other vehicle or wall mounting with the carrier bar when the carrier bar is mounted. Connection mechanisms can be permanently exposed, pulled out when needed and stored safely when not, or covered by one or more movable latches or doors. Connection mechanisms contemplated include standard connection mechanisms currently known and those that are later developed. In some embodiments, specialized wiring and connection mechanisms can be included.

As shown in FIG. 28B an example embodiment diagram 2850 can include wiring 2804 that can be permanently or removably coupled with carrier bar 2802 at external surfaces using adhesives, clips, or other mechanisms 2806. Wiring 2804 can be removably coupled with a vehicle or wall mount's electrical power at an appropriate location and with an appropriate coupling mechanism.

In embodiments where carrier bars include batteries rather than drawing power from a vehicle or wall mount's electrical system, batteries can be removably or permanently coupled inside or outside a carrier bar in an appropriate location. This can include a covered or otherwise protected chamber or box.

It is contemplated that a variety of different types of charging mechanisms may be required different in different embodiments, to account for different power tolerances and other distinctions between different types or models of electrical items to be charged. As such, any number of converters, transformers or other components are contemplated for inclusion in the electrical system.

In some embodiments, on and off switches, different gauges, lighting, and even displays can be provided to indicate the status of charging mechanisms. Timers and automatic features, such as turning off a charging mechanism, can be provided by one or more small computing devices that use one or more processors to execute instructions stored in non-transitory computer readable memory. Other features such as lighting, audio speakers, and others are also contemplated. For example, a hardwired light can be provided in some embodiments that indicates braking or other vehicle conditions.

In some embodiments, multiple charging mechanisms can be included for a carrier bar. As such, multiple electrical items can be charged. In some embodiments, these can be independent, while in others, they can be interdependent and function together as an integrated system.

For electrical mountings provided on an electrical item to be carried or supported by a carrier bar, a male or female trapezoidal or other shaped mount can be removably or permanently coupled to the item. This can in turn be removably or permanently electrically coupled to the battery of the item.

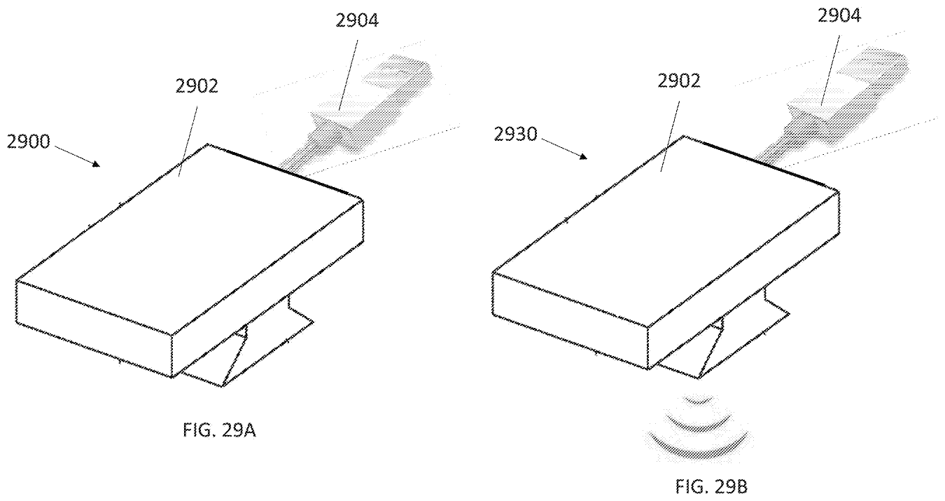

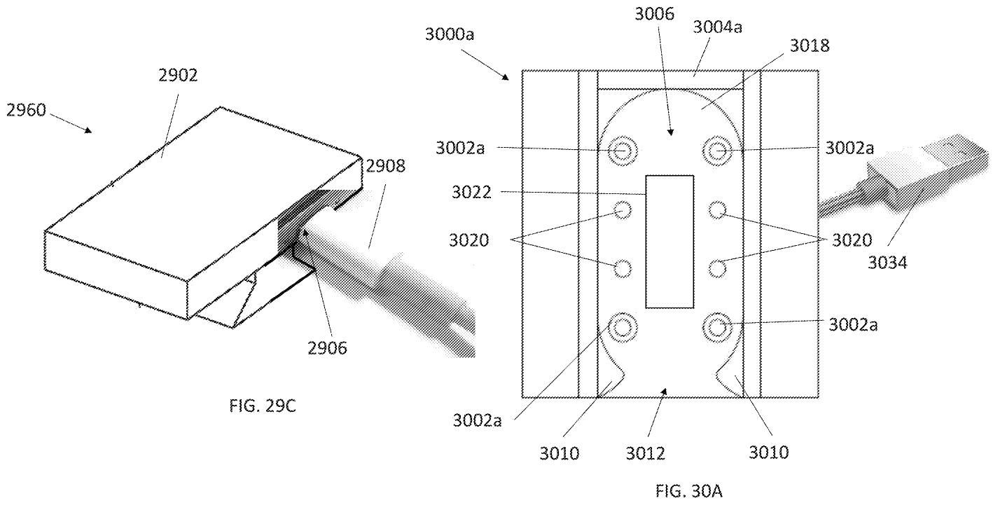

FIG. 29A shows an example embodiment diagram 2900 of a trapezoidal mount 2902 that is not yet mechanically coupled to an item or carrier bar. As shown, a plug 2904 can be provided that powers the mount when plugged in. This can be directly or indirectly coupled with the mount, which may have an internal storage chamber in some embodiments. Here, the mount itself can have one or more electrical connections, such as pads or pins, to provide power from or to the mount when electrically coupled.

FIG. 29B shows an example embodiment diagram 2930 of a trapezoidal mount 2902 that is not yet mechanically coupled to an item or carrier bar. As shown, a plug 2904 can be provided that powers the mount when plugged in. Here, the mount itself can provide or receive power wirelessly, through induction from or to the mount when electrically coupled.

FIG. 29C shows an example embodiment diagram 2960 of a trapezoidal mount 2902 that is not yet mechanically coupled to an item or carrier bar. As shown, a port 2906 can be provided that powers the mount when a power cable 2908 is plugged into it. This port 2906 can be provided on or in one or more surfaces of the mount to provide wired or wireless power.

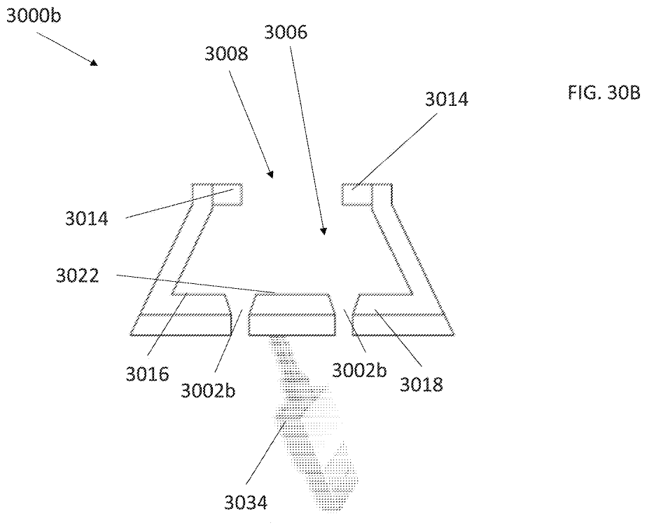

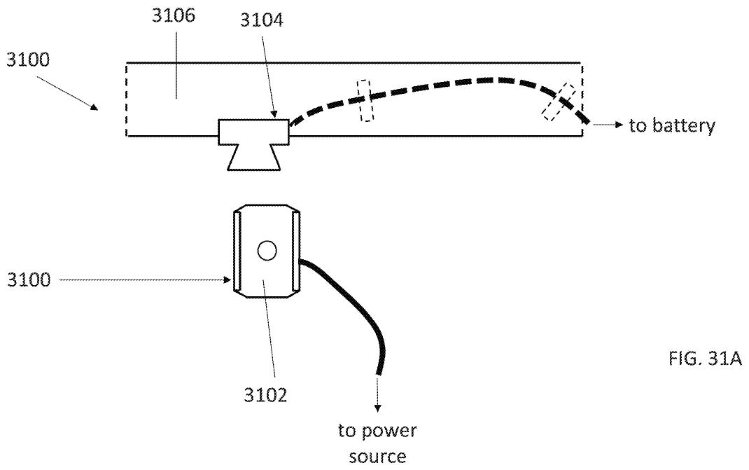

FIG. 30A shows an example embodiment of a top view of a female receiver 3000a. In the example embodiment four main screw holes 3002a are shown as well as four minor screw holes 3020 with different diameters and features. All eight holes 3002a and 3020 can be used in some embodiments where a more secure hold is desired. Any combination of holes might be used in various embodiments, with different numbers of holes as well. In some embodiments, small grooves between the holes could be placed to allow the passage of thread or wire to secure objects to these female trapezoid clips 3000a or to charge a battery. In the example embodiment, a charging pad surface 3022 can provide or receive electrical power to or from a plug 3034, while in some embodiments, ports can be provided.

FIG. 30B shows an example embodiment of a cross sectional view of a female receiver 3000b. In the example embodiment, the trapezoidal female section channel 3006 is shown which receives a complementary male piece. The trapezoidal female section channel 3006 has overhangs 3014 which create a channel 3008 for securing the male portion in place and preventing it from rocking or swaying. Also shown are screw hole channels 3002 with flared top sections such that the top of the screw heads can lie flush with an upper surface 3016 of the bottom section 3018 of the female receiver 3000b. In the example embodiment, a charging pad surface 3022 can provide or receive electrical power to or from a plug 3034, while in some embodiments, ports can be provided

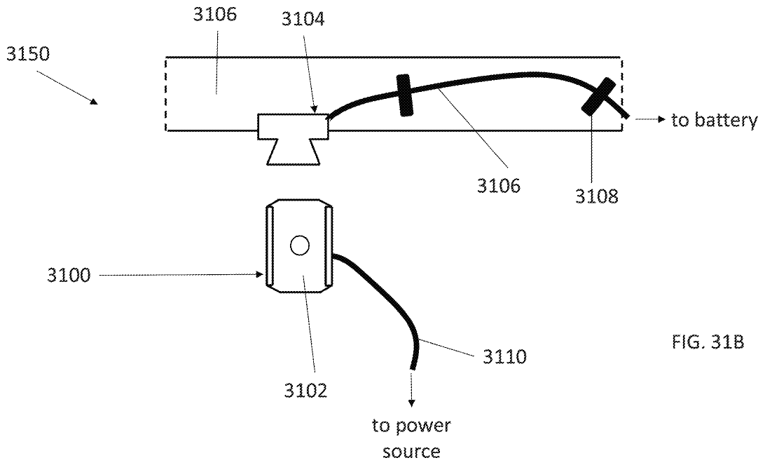

FIG. 31A shows an example embodiment of a female receiver clip 3100 view from above the receiver area 3102 and a side view of a male linking unit 3104 mounted on a bar 3106. In some embodiments an attachment for a male trapezoid 3104 mounted, for instance by welding to a bar 3106 can create a smooth, contoured or otherwise ergonomic surface by coupling it with the male trapezoid so that a user can carry at the welding location easily. In the example embodiment, electrical wiring is shown with a dashed line as being internal within the bar, which connects the mount to a battery. This can be held in place by one or more coupling mechanisms. Also shown is wiring connected to the receiver that can provide power. As such, when electrically and mechanically coupled, the receiver and the mount can be used to power a battery, for instance an electric bicycle battery.

FIG. 31B shows an example embodiment of a female receiver clip 3100 view from above the receiver area 3102 and a side view of a male linking unit 3104 mounted on a bar 3106. In some embodiments an attachment for a male trapezoid 3104 mounted, for instance by welding to a bar 3106 can create a smooth, contoured or otherwise ergonomic surface by coupling it with the male trapezoid 3104 so that a user can carry at the welding location easily. In the example embodiment, electrical wiring 3106 is shown with a solid line as being external on the bar, which connects the mount to a battery. This can be held in place by one or more coupling mechanisms 3108. Also shown is wiring 3106 connected to the receiver that can provide power. As such, when electrically and mechanically coupled, the receiver 3102 can receive power from the mount 3104 that can be used to power a battery via a wire 3110, for instance an electric bicycle battery.

As stated previously, magnetic coupling mechanisms are also contemplated. These can include one or more north, south, or both poles on an item to be carried or supported and one or more north, south, or both poles on a carrier bar. As such, an improved coupling can be provided than in systems without magnets. Electro-magnetic and magnetic couplings can be provided without mechanical couplings or as an added coupling mechanism in addition to mechanical couplings in various embodiments. Where electro-magnetic coupling mechanisms are included, when powered they can provide improved coupling, while when not powered they do not. Thus, they can be simply removed by undoing any mechanical coupling mechanisms when power is off.

Magnets or electro-magnets can be coupled directly to an exterior surface of a carrier bar or coupling mechanism on an item to be carried in some embodiments. In others, magnets can be stored in a removable or permanent compartment at or near a surface of each. This can be in an internal housing that is integrated or coupled with a carrier bar or item in some embodiments. Adhesives or other coupling mechanisms are contemplated in various embodiments.

Additionally, programmable magnets, coded magnets, printed polarity polymagnets, and a variety of other associated magnets and electromagnets are also contemplated. These can provide different types of magnetic fields from conventional magnets. In particular, numerous north and south poles can be provided on a single surface or face. They may have long, medium, or tight reaching fields. As such, they can be used as a “spring” to create a latch by turning about an axis. They can also be used to create gears. Further, the fields can be programmed as “attract-repel” types of magnets such that they attract at a certain distance and then repel once they are close enough together to create a hovering effect. The opposite is also possible to create a “repel-attract” type, where two magnets generally repel until moved close enough together, where they then attract. Also contemplated are magnetic pixels or maxils. These can be used to create tracks or other designs.

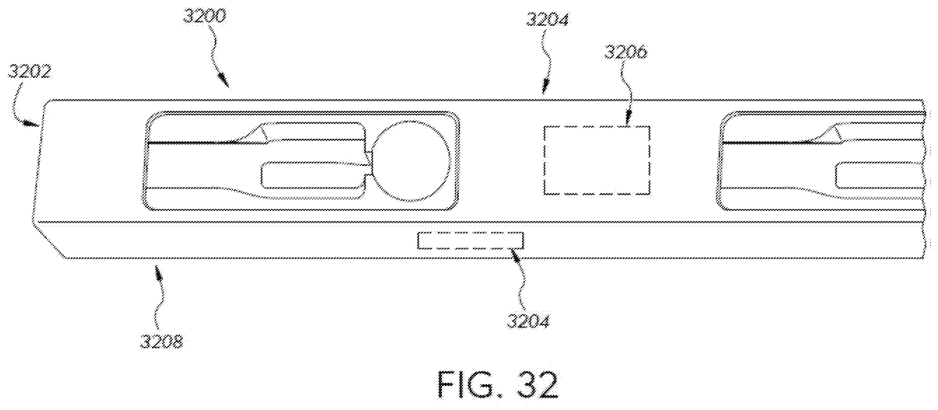

FIG. 32 shows an example embodiment diagram 3200 of a carrier bar and various mounting locations for viewing cameras. In many embodiments of the present invention, carrier bars, carrier racks, and other carrying apparatuses and devices for use in transporting items using vehicles can include digital video cameras. These cameras can be communicatively coupled by wires or wirelessly to one or more user interface displays, head's up displays, monitors, or other viewing devices within the interior of the car. As such, drivers, passengers, or both can view locations outside the vehicle when turned on. These camera and display systems can reduce or eliminate the chances of reversing into other cars, trees, and other moving or stationary obstacles, in addition to reducing or eliminating the risk of running over children, people, animals, or objects, and others.

As shown in the example embodiment, one or more cameras can be removably or permanently coupled with a carrier bar or other device or apparatus at a distal end surface 3202 that points away from the body of the vehicle. They can also be mounted in locations 3208 below carrier bars. Further, they can be mounted at side locations 3204. In some embodiments, they can be mounted at upper surface locations 3206 of the carrier bar. For upper surface locations, they may be elevated above the bar such that they are operable to view over any items that may be coupled for carrying. Some embodiments include a view proximally, toward the vehicle, so as to see the rear of the vehicle or even under the bumper. In some embodiments, they can allow for upward viewing of objects placed above them.

Those in the art will understand that cameras can have a variety of removable or permanent mounting means, which can include adhesives and glues; mechanical coupling means such as screws, nuts, bolts, washers, nails; welds; and others or can be integrated with the body of the carrier bar or other device. Imaging provided by these cameras can be high definition or at least provide an adequate amount of resolution so as to visually capture, process, and provide adequate output for display on a video monitor within the car. In some embodiments, they can have movable lenses that are controllable from within the car. In some embodiments, these movable lenses can automatically move to capture motion, based on visual detection algorithms stored in non-transitory memory.

Further, these cameras may include zoom functionality in various embodiments. In some embodiments, they can pan, swivel, rotate, tilt, or otherwise adjust a viewing angle. In some embodiments, they may be wired into the vehicle's electrical system or be removably coupled therewith. In some embodiments, they can include fish-eye lenses, flat lenses, or other types of lenses and also filters, for example, for night driving. For wireless embodiments, local or other networking capabilities should be included, as appropriate, as well as any power sources or other requirements. Radar, Lidar, and other wireless sensing technology can also be used to monitor, measure, and capture distances to objects, which may then cause displays or vehicle audio or other visual systems to alert the driver of any hazards in the direction being monitored. In some embodiments, visual data or images can be captured and stored in memory, either when an event occurs, within a specific amount of time, when activated, automatically, manually, or based on other criteria. This can be stored locally or transmitted to a remote location via a direct or indirect communicative coupling with a communications or computer network.

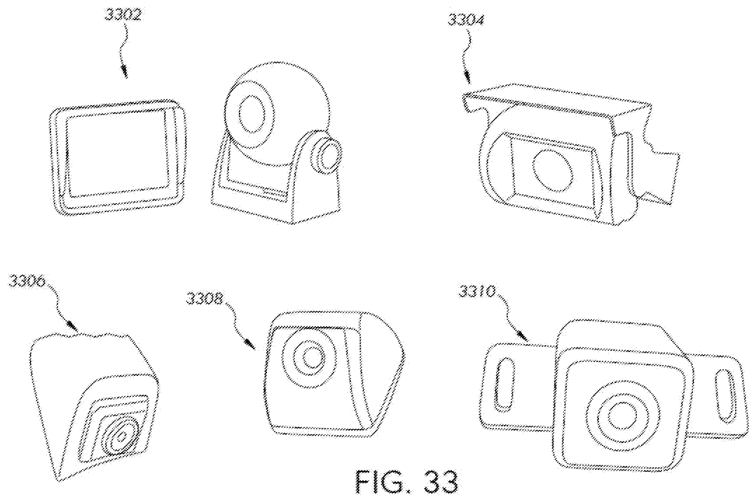

FIG. 33 shows a variety of example embodiments 3302, 3304, 3306, 3308, 3310 of exterior view camera's that can be coupled or integrated with carrier bars and other carrying devices and apparatuses. These can include many mechanical and electrical additional accessories, include lighting, protective housings, movement, coupling means, and others.

Additionally, it should be understood that cameras for use with carrier bars should comply with any current or later developed local or federal regulations, based on the country and locality they are to be used in. For example, in the United States, these regulations can include any regulations put out by the National Highway Traffic Safety Administration (NHTSA) or other governing or administrative body. For the NHTSA, this can include the Federal Motor Safety Vehicle Standards for Rear (or other) Visibility. One example is the FMVSS 111 standards. As such, field of view, image size, test procedures, linger time, deactivation, backing event monitoring, image response time, display luminescence, durability, phase in standards, and various other aspects of use and implementation may be required.

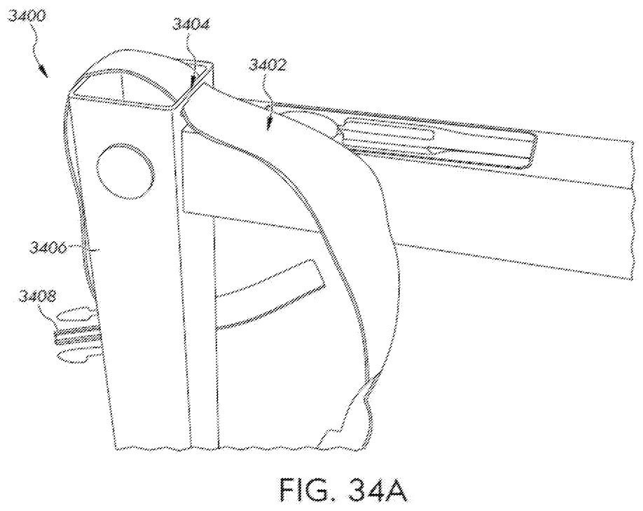

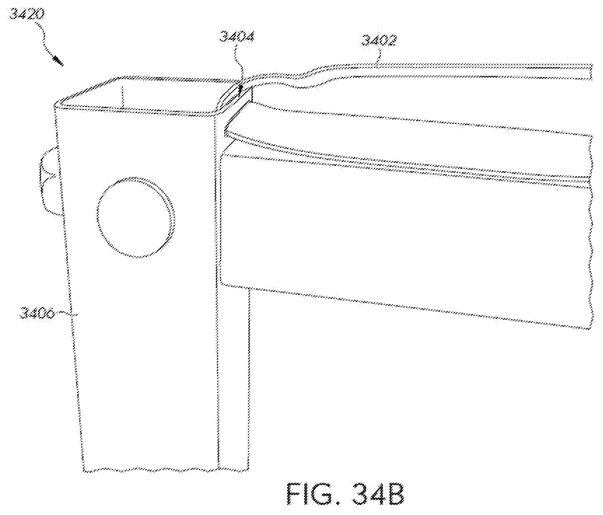

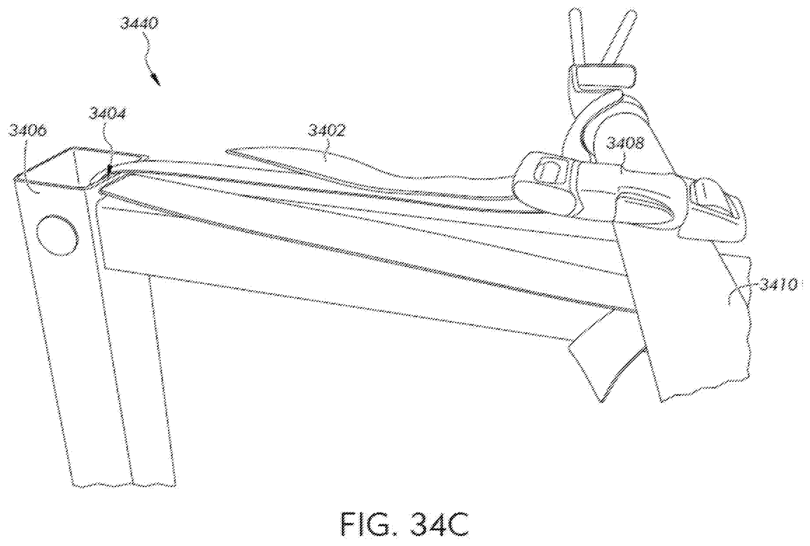

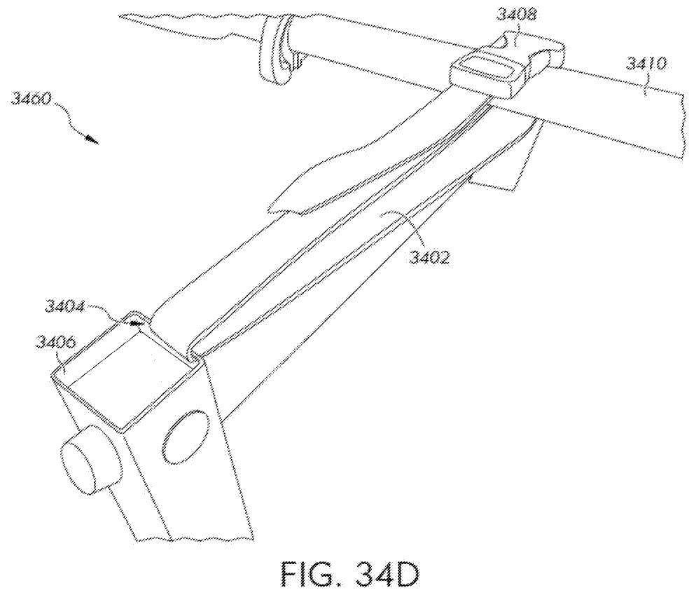

FIGS. 34A-34D show example embodiments images 3400, 3420, 3440, and 3460 of safety straps coupled with cargo carrier bars. As shown, in various embodiments, one or more straps 3402, bands, or devices having similar properties such as free movement can be provided as a backup safety measure for transportation of items using carrier systems or bars 3406. In general, straps 3402 can be a strip or length of fabric, rubber, plastic, or other materials and can include one or more removable or permanent buckles 3408 at or near one or both ends of strap 3402, such that the ends can be securely fastened to each other using the buckle 3408.

Further shown in the example embodiments one or more holes or slots 3404 through one or more walls of carrier bar 3406. Slots 3404 can generally be sized such that it allows strap 3402 to be passed through and looped out of an interior of, or otherwise coupled with, carrier bar 3406.

As shown in FIGS. 34C-34D, when in use for carrying or transporting an item such as an adaptor bar 3410 (e.g. see FIGS. 20-23 and 26A-26H), bicycle bar, or other item, strap 3402 can be looped at least around the bar 3410 and buckle 3408 can be secured and tightened if necessary. This can provide an additional measure of safety, by which a taut or otherwise secured strap 3402 holds bar 3410 in place and prevents it from moving back and forth. Additionally, if bar 3410 were to jostle or otherwise come free of carrier bar system 3406, strap 3402 would still be looped around it, thus preventing adaptor bar 3410 from completely falling free and potentially injuring persons or property which may be following a vehicle equipped with carrier bar system 3406. It should be understood that multiple loops and different orientations of strap 3402 can be provided in various embodiments, as well as additional safety features such as slits, slots, or holes through adaptor bar 3410, different sections of carrier bar 3406, and others.

As used herein and in the appended claims, the singular forms “a”, “an”, and “the” include plural referents unless the context clearly dictates otherwise.

The publications discussed herein are provided solely for their disclosure prior to the filing date of the present application. Nothing herein is to be construed as an admission that the present disclosure is not entitled to antedate such publication by virtue of prior disclosure. Further, the dates of publication provided may be different from the actual publication dates which may need to be independently confirmed.

It should be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the following description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

In many instances, entities are described herein as being coupled to other entities. It should be understood that the terms “coupled” and “connected” (or any of their forms) are used interchangeably herein and, in both cases, are generic to the direct coupling of two entities (without any non-negligible (e.g., parasitic) intervening entities) and the indirect coupling of two entities (with one or more non-negligible intervening entities). Where entities are shown as being directly coupled together or described as coupled together without description of any intervening entity, it should be understood that those entities can be indirectly coupled together as well unless the context clearly dictates otherwise.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

What is claimed is:

1. A removable adaptor bar device for coupling with and securely transporting a bicycle using a vehicle, comprising:
an outer sleeve;
an inner sleeve, operable to slidably engage with the outer sleeve;
an adjustable clamp for securing the outer and inner sleeves in a fixed position with respect to each other;
a first engagement mechanism coupled with an end of the outer sleeve;
a second engagement mechanism coupled with an end of the inner sleeve and opposite the first engagement mechanism; and
a primary coupling mechanism for coupling with a complementary coupling mechanism of a transportation or storage apparatus,
wherein the first and second engagement mechanisms are operable to couple with a seating post of a bicycle and a post near handlebars of the bicycle for securing the bicycle during transportation or storage.

2. The removable adaptor bar device for coupling with and securely transporting a bicycle using a vehicle of claim 1, wherein the first engagement mechanism is a hook.

3. The removable adaptor bar device for coupling with and securely transporting a bicycle using a vehicle of claim 2, further comprising:
a first secondary coupling mechanism coupled to the hook.

4. The removable adaptor bar device for coupling with and securely transporting a bicycle using a vehicle of claim 3, further comprising:
a second secondary coupling mechanism coupled to the hook,
wherein the first secondary coupling mechanism is coupled with the second secondary coupling mechanism using a strap.

5. The removable adaptor bar device for coupling with and securely transporting a bicycle using a vehicle of claim 1, wherein the primary coupling mechanism is a male engagement piece that is operable to engage with a female engagement receiver for storage and transportation of the adaptor bar.

6. The removable adaptor bar device for coupling with and securely transporting a bicycle using a vehicle of claim 5, wherein the male engagement piece has a trapezoidal cross section.

7. The removable adaptor bar device for coupling with and securely transporting a bicycle using a vehicle of claim 1, wherein the second engagement mechanism is a clamp.

8. The removable adaptor bar device for coupling with and securely transporting a bicycle using a vehicle of claim 7, wherein the clamp comprises:
a first arm and a second arm that are oriented in opposing positions and are operable to removably and securely grasp a bicycle bar.

9. The removable adaptor bar device for coupling with and securely transporting a bicycle using a vehicle of claim 8, wherein the clamp further comprises:
a cam locking mechanism.

10. The removable adaptor bar device for coupling with and securely transporting a bicycle using a vehicle of claim 8, wherein the first arm of the clamp further comprises:
a first threaded hole through the first arm that is operable to receive a threaded post to articulate the first and second arms with respect to each other.

11. The removable adaptor bar device for coupling with and securely transporting a bicycle using a vehicle of claim 10, wherein the second arm of the clamp further comprises:
a second threaded hole through the second arm that is operable to receive a threaded post to articulate the first and second arms with respect to each other.

12. The removable adaptor bar device for coupling with and securely transporting a bicycle using a vehicle of claim 11, wherein the first and second threaded holes have opposite orientations and wherein the threaded post has two sections with opposite orientations.

13. The removable adaptor bar device for coupling with and securely transporting a bicycle using a vehicle of claim 8, wherein the clamp further comprises:
an end piece located near a hinge between the first and second arms that is operable to removably couple the clamp with the end of the inner sleeve.

14. The removable adaptor bar device for coupling with and securely transporting a bicycle using a vehicle of claim 8, wherein the clamp further comprises:
a first gripping surface on an inward facing side of the first arm; and
a second gripping surface on an inward facing side of the second arm.

15. The removable adaptor bar device for coupling with and securely transporting a bicycle using a vehicle of claim 8, wherein the clamp further comprises:
a clamp coupling feature that is coupled to the first arm; and
a strap, coupled to the second arm that is operable to be coupled with the clamp coupling feature around a bar of the bicycle.
